(19) United States
(12) Patent Application Publication
(10) Pub. No.: US 2011/0234095 A1
(43) Pub. Date: Sep. 29, 2011

(54) Integrated Gas Discharge Lamp having Constant Light Emission During the Burning Time

(76) Inventor: Bernhard Siessegger, Munchen (DE)

(21) Appl. No.: 13/132,076

(22) PCT Filed: Nov. 17, 2009
(86) PCT No.: PCT/EP2009/065328

§ 371 Date: May 31, 2011

(30) Foreign Application Priority Data
Nov. 28, 2008 (DE) 1020080594830

(51) Int. Cl. H01J 61/56

(52) U.S. Cl. 315/51

(57) ABSTRACT

An integrated gas discharge lamp (5), wherein a gas discharge lamp burner (50) and operating electronics (920, 930) for the gas discharge lamp burner (50) are integrated in a lamp, and wherein the operating electronics (920 930) control the power of the gas discharge lamp burner (50) as a function of the burning time (t) thereof in such a way that the level of the light output of the integrated gas discharge lamp (5) follows a target value curve

$$( \frac{{φ}_{target}}{{φ}_{N}} ) .$$

### TECHNICAL FIELD

The invention relates to an integrated gas discharge lamp, wherein a gas discharge lamp burner and operating electronics for the gas discharge lamp burner are integrated in a lamp.

### PRIOR ART

The invention starts from an integrated gas discharge lamp, wherein a gas discharge lamp burner and operating electronics for the gas discharge lamp burner are integrated in a lamp of the kind according to the main claim.

A method for stabilizing and controlling the photometric properties of metal halide high-pressure discharge lamps is known from DE 195 29 460. In the method the photometric data is derived from the dynamic behavior of the lamp and the photometric data is adjusted by an appropriate controller in accordance with the specifications.

However, the method has the drawback that a complex model is required for calculating the photometric data. A comparatively complex circuit arrangement is also necessary to obtain sufficiently accurate measured values for the dynamic behavior of the lamp.

### OBJECT

It is the object of the invention to disclose an integrated gas discharge lamp, wherein a gas discharge lamp burner and operating electronics for the gas discharge lamp burner are integrated in a lamp, which carries out a simpler method for adjusting photometric data.

### DESCRIPTION OF THE INVENTION

The solution to the object takes place according to the invention with an integrated gas discharge lamp, wherein a gas discharge lamp burner and operating electronics for the gas discharge lamp burner are integrated in a lamp, wherein the operating electronics control the power of the gas discharge lamp burner as a function of the burning time thereof in such a way that the level of the light output of the integrated gas discharge lamp follows a target value curve

$$( \frac{{φ}_{target}}{{φ}_{N}} ) .$$

This ensures simple and inexpensive control of the photometric data from the lamp. The target value is preferably always the same over the entire lifetime of the integrated gas discharge lamp.

The operating electronics of the integrated gas discharge lamp preferably comprise a non-volatile memory, and detect and total the burning time of the gas discharge lamp burner and store it as a cumulative burning time in the non-volatile memory of the operating electronics. They can therefore refer to the cumulative burning time of the gas discharge lamp burner at any time.

The operating electronics calculate the power to be output to the gas discharge lamp burner from at least the following data stored in a non-volatile memory:
the cumulative burning time,
the burner start counted by the operating electronics,
the gas discharge lamp burner data,
a compensation function. The photometric properties of the gas discharge lamp burner of the integrated gas discharge lamp can be adjusted very accurately by way of this measure.

The gas discharge lamp burner data is preferably written into the non-volatile memory during production of the integrated gas discharge lamp. This data can consequently be referred to during operation and the precision of the photometric data is refined further.

In a preferred embodiment the integrated gas discharge lamp comprises a communications interface. Data can consequently be written into the lamp even after production and read out of the lamp. The integrated gas discharge lamp is preferably connected via the communications interface to a higher-level control system and is controlled by this. The integrated gas discharge lamp can consequently receive default values and adjust them. If the integrated gas discharge lamp receives data via the communications interface about an optical system on which it is operated and includes this data in the calculation of the power to be output to the gas discharge lamp burner, it can accurately adjust the photometric data of the entire system in addition to the photometric data of the burner over its lifetime.

If the integrated gas discharge lamp comprises a communications interface the gas discharge lamp burner data can be written into the non-volatile memory via the communications interface during production of the integrated gas discharge lamp. The functionality of the memory can also be directly tested during production. As the integrated gas discharge lamp can store information about operation of the gas discharge lamp burner in the non-volatile memory this information can be retrieved by the higher-level control system. The control system is therefore always informed about the state of the integrated gas discharge lamp.

The cumulative burning time is preferably weighted with a weighting function to form a cumulatively weighted burning time. This significantly increases the precision of the lifetime prediction of the integrated gas discharge lamp, primarily if the integrated gas discharge lamp is designed to operate the gas discharge lamp burner with over- or underpower.

The integrated gas discharge lamp calculates a power as a function of
the cumulatively weighted burning time,
the burner start counted by the operating electronics,
the gas discharge lamp burner data,
a compensation function and
a dimming curve,
which power is applied to the gas discharge lamp burner (50) as a function of a higher-level control system which can specify a target light flux. It is therefore possible for the higher-level control system to easily control the light output of the total optical system.

The dimming curve can be a three-dimensional characteristic diagram but may also be a function from which the three-dimensional characteristic diagram can be calculated. This is advantageous in the case of a simple circuit arrangement with little memory space in the microcontroller.

Further advantageous developments and embodiments of the inventive integrated gas discharge lamp emerge from the further dependent claims and from the following description.

### BRIEF DESCRIPTION OF THE DRAWING(S)

Further advantages, features and details of the invention emerge with reference to the following description of exemplary embodiments and with reference to the drawings in which identical elements or elements with the same function are provided with identical reference characters, and in which:

FIG. 1 shows a sectional view of an inventive integrated gas discharge lamp in a first embodiment,

FIG. 2 shows an exploded view of the mechanical components of the integrated gas discharge lamp in the first embodiment,

FIG. 3 shows a sectional view of an inventive integrated gas discharge lamp in a second embodiment,

FIG. 4 shows a perspective view of an inventive integrated gas discharge lamp in a second embodiment,

FIG. 5 shows a view of the headlight/gas discharge lamp interface,

FIG. 6 shows a detailed view of the electrical contacts,

FIG. 7 shows a detailed view of the mechanical contacts,

FIG. 8 shows a sectional view of a third embodiment of the integrated gas discharge lamp,

FIG. 9 shows a perspective view of an inventive integrated gas discharge lamp in a fourth embodiment,

FIG. 10 shows a perspective view of an ignition transformer of the integrated gas discharge lamp,

FIG. 11 shows a perspective view of the upper part of the ignition transformer,

FIG. 12 shows a perspective view of the lower part of the ignition transformer,

FIG. 13 shows a perspective view of the lower part of the ignition transformer with visible secondary winding,

FIG. 14 shows an exploded view of the ignition transformer in a second round embodiment,

FIG. 15 shows a sectional view of the ignition transformer in a second round embodiment,

FIG. 16 shows an exploded view of the ignition transformer in a third round embodiment with a two-turn primary winding,

FIG. 17 shows a sectional view of the ignition transformer in a third round embodiment with a two-turn primary winding,

FIG. 18a shows a schematic circuit diagram of an asymmetrical pulse ignition according to the prior art,

FIG. 18b shows a schematic circuit diagram of a symmetrical pulse ignition device according to the prior art,

FIG. 19 shows a schematic circuit diagram of an asymmetrical pulse ignition device,

FIG. 20 shows a schematic circuit diagram of an expanded circuit of the integrated gas discharge lamp,

FIG. 21 shows a sectional view of the gas discharge lamp burner of the integrated gas discharge lamp with the base construction,

FIG. 22 shows a diagram of the operating frequency of the gas discharge lamp burner over its burning time,

FIG. 23 shows a circuit topology for a mode of operation with straightened discharge arc in a first embodiment,

FIG. 24 shows a circuit topology for a mode of operation with straightened discharge arc in a second embodiment,

FIG. 25 shows a circuit topology for a mode of operation with straightened discharge arc in a third embodiment,

FIG. 26 shows a circuit topology for a simplified mode of operation of a DC/DC converter,

FIG. 27 shows a graph which illustrates the functional relationship between the normalized target burning power and the cumulatively weighted burning time of the gas discharge lamp burner,

FIG. 28 shows a graph of the weighting function γ,

FIG. 29 shows a graph of the function α,

FIG. 30 shows a graph of the normalized target light flux as a function of the normalized cumulative burning time of the gas discharge lamp burner,

FIG. 31 shows a sectional view of an inventive integrated gas discharge lamp in a fifth embodiment,

FIG. 32 shows a flow chart of a variant of a first embodiment of a method for operating an integrated gas discharge lamp,

FIG. 33 shows a flow chart of a further variant of the first embodiment of the method for operating an integrated gas discharge lamp,

FIG. 34 shows a flow chart of a second embodiment of a method for operating an integrated gas discharge lamp.

### PREFERRED EMBODIMENT OF THE INVENTION

### Mechanical Integration

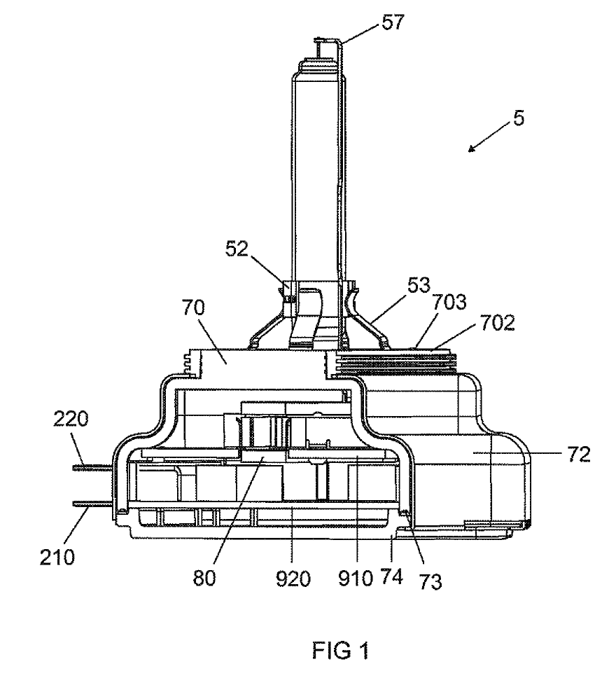

FIG. 1 shows a sectional view of a first embodiment of the integrated gas discharge lamp 5. An integrated gas discharge lamp 5 is hereinafter designated as a gas discharge lamp 5 which has both the ignition electronics and the operating electronics integrated in the lamp base of the gas discharge lamp 5. The integrated gas discharge lamp 5 therefore no longer comprises a specific lamp interface to the outside. Instead it can be directly connected to generally conventional and common power supply networks. In an embodiment as a vehicle headlight the interface of the integrated gas discharge lamp 5 is therefore the conventional 12 V supply of the on-board power supply. In a further embodiment as a vehicle lamp the interface of the integrated gas discharge lamp 5 can also be a future 42 V supply of a modern on-board power supply. The integrated gas discharge lamp 5 can, however, also be designed to be connected to the high-voltage on-board power supply of an electric car with a battery voltage of, for example, 48 V, 96 V, 120 V up to, by way of example, 360 V. The integrated gas discharge lamp 5 can also be adapted to work on an emergency power supply with a battery-backed low voltage network. This lamp may also be used in low voltage island networks, as are used for example in mountain shelters. Conventional low voltage systems in which low voltage halogen lamps were previously used are also conceivable as an application here. A lamp of this kind is even advantageous in portable devices such as flashlights as no wiring is required between lamp and operating device. As a result of the fact that the wire is omitted, additional costs, wiring complexity and unnecessary sources of error are eliminated. Therefore an integrated gas discharge lamp 5 is hereinafter taken to mean a gas discharge lamp which has all of the electronics required for operation integrated in the lamp itself, so it can be directly connected to a conventional power supply.

A lamp burner 50 is secured by a metal clip 52 which is provided on four retaining plates 53. The retaining plates 53 are cast or injected into a lamp base 70. The lamp base 70 is preferably made of plastic and is produced by an injection molding process or a casting method. To improve the electrical shielding, the plastic of the lamp base 70 can be electrically conductive or metalized. Metallization of the lamp base on the outside is particularly advantageous, therefore on the side facing away from the ignition and operating electronics 910, 920. In addition to metallization it is also possible to overmold metallic conductors or a metallic mesh, so an electrically conductive skin is produced which is situated in the wall of the lamp base 70. If no conductive or metalized plastic is used, the plastic base is surrounded by an electrically conductive housing 72 made of a conductive material, such as metal. The metal can, for example, be a corrosion-protected iron sheet or a non-ferrous metal such as aluminum, magnesium or brass. A sealing ring 71, commonly also called an O-ring, is located at the burner-side end of the electrically conductive housing 72 and provides a seal with respect to the reflector. As a result of this measure a sealed headlight system can be constructed without the lamp having to be installed in its entirety in a sealed headlight. As a result of the fact that the lamp is located on the outside of the headlight, cooling of ignition and operating electronics 910, 920 situated in the base is much improved and simpler than with a conventional construction in which the gas discharge lamp 5 is installed in a sealed headlight in which only weak cooling convention may take place. The almost stationary air inside the described, sealed headlight causes what is referred to as heat build-up which leads to significantly higher temperatures of the operating electronics than in the proposed embodiment in which the lamp protrudes into the open, for example into the engine compartment, on the side facing away from the light-emitting surface.

The base 70 is closed by a base plate 74 on the side facing away from the lamp burner 50. The base plate 74 is preferably made from a highly thermally and electrically conductive material, such as aluminum or magnesium. To produce a mechanical connection to the base 70 and an electrical connection to the electrically conductive housing 72 the housing comprises a plurality of tongues 722 on the side facing away from the lamp burner 50, which are flanged onto the base plate 74 when the integrated gas discharge lamp 5 is assembled and thus produce the required connections. Lamp burner 50, ignition electronics 910 and operating electronics 920 are inseparably connected to each other to form an integrated gas discharge lamp 5 by this type of connecting method inter alia. This has the advantage for the motor vehicle manufacturer that, in contrast to conventional systems which comprise an operating device and a gas discharge lamp, the integrated gas discharge lamp 5 is still only one piece in terms of logistics and in the case of assembly, the lower complexity leads to reduced costs and a danger of confusion between components with the same function but a different design, such as different product versions of the operating devices, is eliminated. For the end customer, by way of example the vehicle owner, this results in the advantage that the reduced complexity significantly simplifies and speeds up the replacement of a defective integrated gas discharge lamp compared with the prior art, facilitates fault finding and less knowledge and fewer skills are required for changing a lamp. The omission of cables and connectors between the components also reduces costs, increases reliability and reduces the weight.

The base plate is preferably made from die cast aluminum or die cast magnesium. This is an inexpensive as well as a mechanically and electrically high-quality variant. A highly electrically conductive connection between the at least superficially electrically conductive lamp base 70 or the electrically conductive housing 72 and the likewise electrically conductive base plate 74 is particularly necessary for good electromagnetic shielding. This shielding prevents interference with adjacent electrical or electronic modules. The shielding also ensures that the modules do not have an adverse effect on the function of the ignition and operating electronics 910, 920. A sealing ring 73 is arranged between the base plate 74 and base 70 and ensures a water- and airtight connection between the base 70 and base plate 74. In an alternative embodiment the base 70 and the base plate 74 are configured in such a way that both parts can latch with each other and in the latched position one or more contact point(s) simultaneously exist(s) between the electrically conductive housing 72 and the base plate 74 to produce a good connection for the electrical shielding. A sealing ring is again arranged between base and base plate in this case and ensures the tightness of the base on the side facing away from the gas discharge lamp burner 50. Two planes are provided inside the base 70 which receive the ignition and operating electronics. A first smaller plane, which is closest to the lamp burner 50, receives the ignition electronics 910 with the ignition transformer 80. The construction of the ignition transformer 80 will be discussed later. A second larger plane receives the operating electronics 920 required for operating the discharge lamp burner 50. The ignition and operating electronics can be located on any suitable type of printed circuit board, also called a PC board. Possibilities include conventional printed circuit boards, metal core printed circuit boards, printed circuit boards using LTCC technology, oxidized or coated metal boards with conductor tracks using thick film technology, plastic printed circuit boards using MID or MID hot stamping technology or other suitable possible technologies for producing temperature-resistant printed circuit boards. The electronic components and elements which form the ignition and operating electronics can be located on the top or bottom or inside the two printed circuit boards respectively. In FIG. 1, apart from the transformer 80, no additional electronic components or elements are shown on the printed circuit board for the sake of clarity. If the printed circuit board for the ignition electronics 910 and the printed circuit board for the operating electronics 920 are made from the same material they can advantageously be manufactured on the same panel. Bridges can be assembled between the printed circuit boards which serve as electrical connections between the printed circuit boards during separation and introduction into the lamp base 70. Single wires, ribbon cables or rigid-flexible printed circuit boards by way of example can serve as bridges. The electrical connection of the two printed circuit boards is designed in such a way that it survives a change in the spacing between the two printed circuit boards of the ignition and operating electronics due to thermal expansion, in particular due to a thermal cyclical stress, undamaged. For this purpose the wires are, by way of example, to be provided with sufficient length and appropriate installation inside the housing. Alternatively, one or more plug and socket connector(s), by way of example, can be used which are dimensioned and arranged in such a way that they allow thermal expansion in the direction of the longitudinal axis of the gas discharge lamp burner of the two printed circuit boards and still ensure an electrical connection in all cases. The pins of the plug connector for example are arranged perpendicular to the respective surface of the printed circuit board for this purpose and the insertion length of the sockets is dimensioned such that they provide more distance for the pins than they require due to the thermal expansion inside the sockets.

On the side facing the operating electronics the printed circuit board for the ignition electronics 910 comprises an electrically conductive shielding surface to keep interference which comes about due to the high voltage in the ignition electronics as far away from the operating electronics as possible. This surface inherently exists in a metallic or metal core printed circuit board; with other printed circuit board materials a copper surface or the like is preferably applied to this side. If a metal core printed circuit board is used, then the ignition transformer 80, which owing to proximity to the gas discharge lamp burner 50 is exposed to particularly high thermal stress, can also be cooled by it. An electrically conductive shielding surface between the ignition electronics 910 and the operating electronics 920 can alternatively also be provided by way of a metallic sheet which is introduced between the two printed circuit boards and is advantageously electrically conductively connected to the electrically conductive housing 72. If this shielding surface is also to be used for cooling the ignition transformer 80, it is advantageous if the metallic sheet also has a good thermal connection, for example by way of a heat conducting film or heat conducting paste, to the electrically conductive housing 72.

The printed circuit board for the operating electronics 920 is clamped between the base 70 and the base plate 74. The printed circuit board for the operating electronics 920 has at its periphery an encircling ground conductor track, what are referred to as grounding rings, on the top and bottom respectively, which are electrically conductively connected together owing to plated through-contacts. These plated through-contacts are conventionally called vias and are electrical contacts which run through the printed circuit board. These grounding rings establish an electrical contact with the base plate 74 due to the clamping between the base 70 and the base plate 74, ensuring the grounding connection of the operating electronics 920 to the electrically conductive housing 72 via the flanged tongues 722.

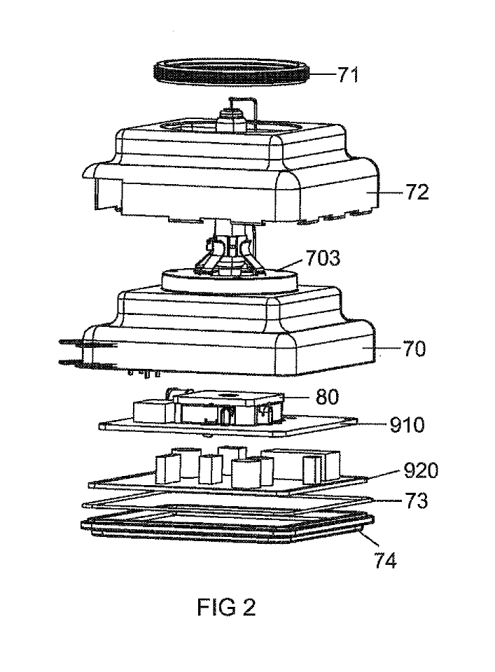

FIG. 2 shows an exploded view of the mechanical components of the integrated gas discharge lamp in the first embodiment. Here the base is square but in principle it can also have many other suitable forms. Particularly advantageous further embodiments would be round, hexagonal, octagonal or rectangular. For determining the external contour of the embodiment an imaginary cut is made perpendicular to the longitudinal axis of the gas discharge lamp burner 50 through the housing part containing the electronics and the resulting external contour considered, wherein curves on the housing edges are to be ignored. In the case of the first embodiment shown in FIGS. 1 and 2 two squares are produced as a function of whether the chosen cut surface is located closer to the ignition electronics 910 or the operating electronics 920. The first embodiment is therefore a square embodiment. The first resulting external contour in the proximity to the ignition electronics 910 is smaller than the second, and this is substantially caused by the fact that the printed circuit board of the ignition electronics 920 has smaller dimensions than that of the operating electronics 910. However, this does not have to be the case and an embodiment in which the two external contours are the same size, and there is consequently only a single external contour, is possible. The two geometries of the external contours do not have to be identical in the different regions either. In particular a small, round external contour in the region of the ignition electronics and a larger, hexagonal external contour in the region of the operating electronics seems to be a particularly advantageous embodiment.

The printed circuit board for the operating electronics 920 is, as already illustrated above, clamped between the base 70 and the base plate 74. The sealing ring 73, like the printed circuit board for the operating electronics 920, comes to rest between the base 70 and the base plate 74 and is arranged outside of the printed circuit board for the operating electronics 920.

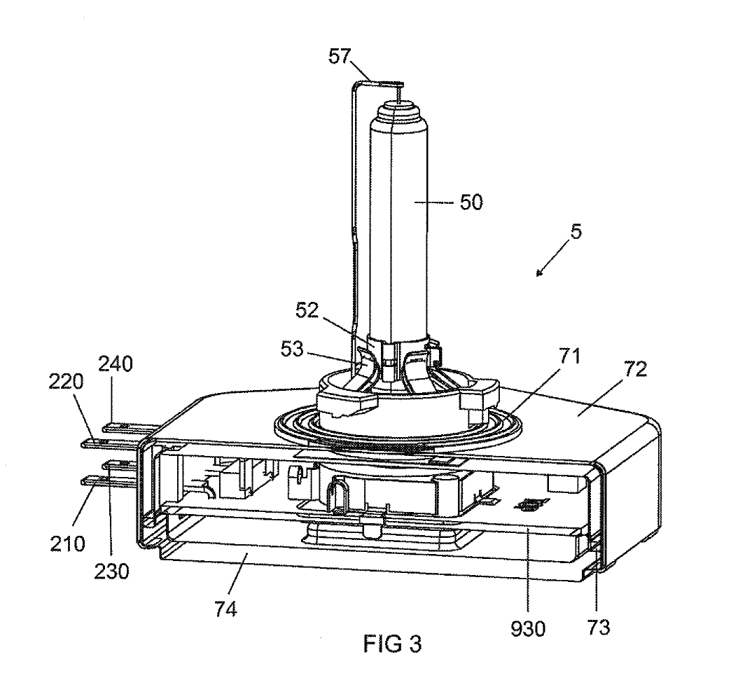

FIG. 3 shows a sectional view of a second embodiment of the integrated gas discharge lamp 5. The second embodiment is similar to the first embodiment and therefore only the differences from the first embodiment will be described. In the second embodiment the ignition electronics 910 and the operating electronics 920 are arranged as overall operating electronics 930 in a common plane on a printed circuit board. As a result of this measure the base of the inventive gas discharge lamp 5 can be flatter so a headlight, which uses this gas discharge lamp 5, also has less depth. The ignition transformer 80 is located centrally under the gas discharge lamp burner 50. The center of the ignition transformer 80 is preferably located in the longitudinal axis of the gas discharge lamp burner 50. The power supply for the gas discharge lamp burner electrode that is close to the base projects into the central part of the ignition transformer. The ignition transformer is not mounted on the printed circuit board but with its end remote from the gas discharge lamp burner is located substantially at the same level as the side of the printed circuit board facing away from the gas discharge lamp burner. For this purpose the printed circuit board of the overall operating electronics 930 is recessed at this location so the ignition transformer 80 is inserted into the printed circuit board of the overall operating electronics 930. To improve electromagnetic compatibility the housing, for example by way of webs made of aluminum sheet or Mu metal, can be provided with walls and chambers and electrical, magnetic and electromagnetic shielding of different circuit parts from each other and from the environment can be provided as a result. The shielding can also be achieved by other measures, in particular the formation of cavities in the base plate 74 and in the lamp base 70 can be easily attained as part of the injection molding process.

The remaining cavities inside the housing of the integrated gas discharge lamp 5, in particular around the ignition transformer 80 and on both sides of the overall operating electronics 930, are filled with casting compound. This has several advantages. Thus, by way of example, electrical flashovers, in particular due to the high voltage generated by the ignition transformer, are reliably prevented, good thermal dissipation of the electronics is ensured and a mechanically very robust unit is created which withstands environmental effects in particular, such as moisture and high accelerations, very well. Only a partial casting, for example in the region of the ignition transformer 80, can however also be implemented in particular to reduce the weight.

FIG. 8 shows a third embodiment of the inventive integrated gas discharge lamp 5. The third embodiment is similar to the first embodiment, therefore only the differences from the first embodiment will be described. In the third embodiment the base plate 74 is provided with cooling fins on its outside. It is also conceivable to provide the lamp base 70 and the electrically conductive housing 72 respectively with cooling fins. Furthermore, the function of the printed circuit board of the operating electronics 920 is also fulfilled by the base plate as this has electrically non-conducting regions on its inside, for example regions made of anodically oxidized aluminum, which are provided with conducting structures, for example conductor tracks using thick film technology, and which are connected in an electrically conducting manner, for example by soldering, to the components of the overall operating electronics. The operating electronics 920 are cooled particularly effectively as a result of this measure because they are provided directly on a cooling body. The cooling fins are preferably designed in such a way that natural convention is promoted when the integrated gas discharge lamp 5 is installed. If the integrated gas discharge lamp 5 is to be operated in different installation positions, the cooling surface can also be designed accordingly and, for example, consist of round, hexagonal, square or rectangular fingers, so natural convection can take place in a plurality of spatial directions. As in the first embodiment the ignition electronics 910 are located on a printed circuit board situated above and are electrically connected to the operating electronics 920 by suitable measures. This can be brought about by way of spring contacts or plug-in contacts but also by way of conductor tracks extending in the base or conductor tracks impressed on the inside of the base, which are connected to the ignition electronics 910 and the operating electronics 920.

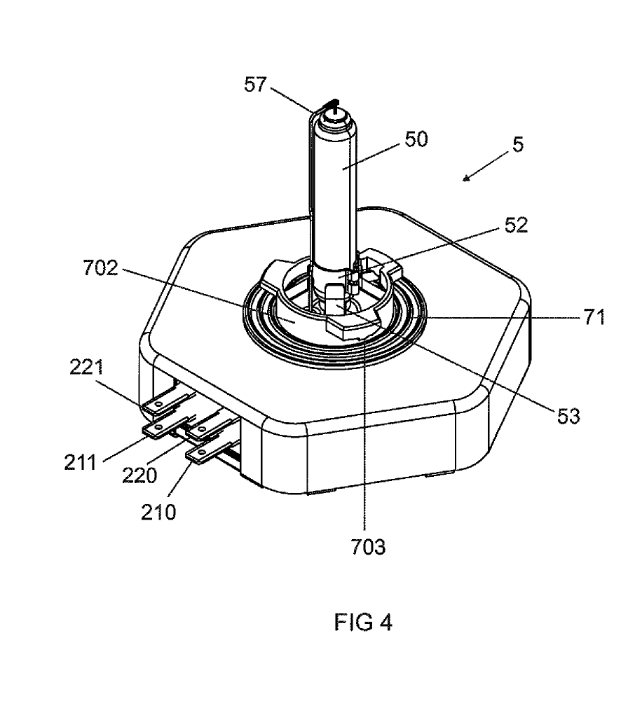

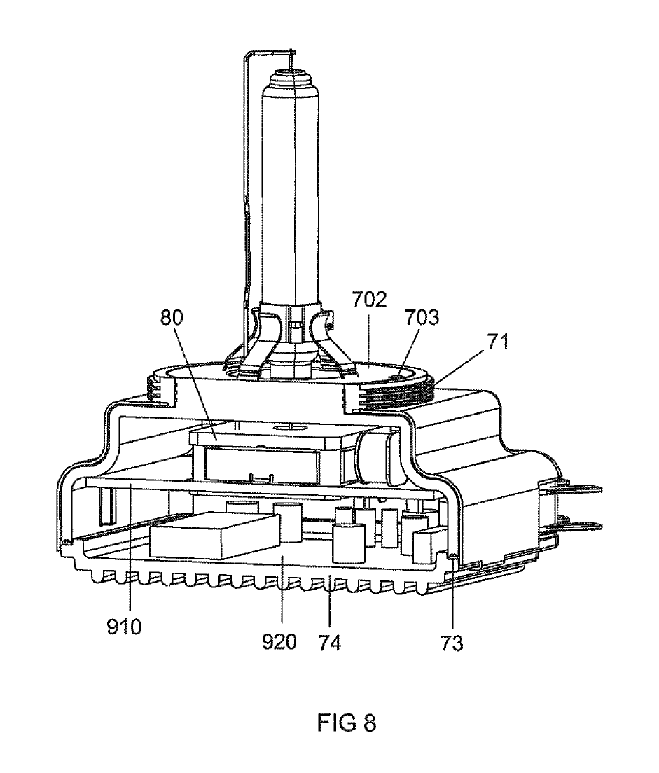

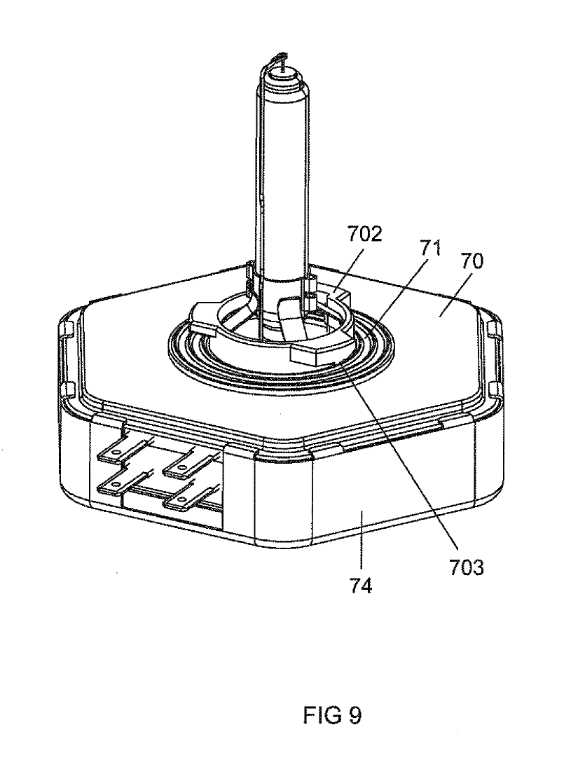

FIG. 9 shows a fourth embodiment of the inventive integrated gas discharge lamp 5. The fourth embodiment is similar to the second embodiment and therefore only the differences from the second embodiment will be described. In the fourth embodiment the base plate 74 is implemented by a metal core printed circuit board populated on the inside and therefore also on one side as in the previous exemplary embodiment. The base plate 74 is no longer a plate, however, as in FIG. 4 but a base cup with raised side walls. The base plate will therefore be called a base cup hereinafter for reasons of clarity. The base cup can also be made of a highly thermally conductive material. Metal alloys which can be effectively reshaped, for example by deep drawing, are particularly suitable. A plastic that is highly thermally conductive and which can be brought into shape by injection molding is also very suitable. The base 70 with the reference ring 702 and the reference knobs 703 consist in this embodiment substantially of a hexagonal plate on which the burner is adjusted and secured inside the reference ring. The base cup accommodates the overall operating electronics 930 which are located on their own printed circuit board or on the inner bottom of the base cup. Plug-in contacts are provided on the power supply lines 56, 57 of the gas discharge lamb burner 50 and when the base cup and the base 70 are assembled these engage in corresponding counter contacts of the base cup and produce a reliable contact.

If the base cup and the base 70 are made of metal the two parts can be connected by flanging as in the case of a coffee tin or tin can. However, as shown in FIG. 9, a plurality of tongues of the base cup could also simply be flanged onto the base to produce a good mechanical and electrical connection. To establish the connection known soldering and welding methods may also be used, however.

If the base cup and the base 70 are made of plastic the connection can preferably be made by ultrasonic welding. This produces a reliable and permanent connection which in the case of a conductive plastic also produces a conductive connection. The connection can, however, also be produced by appropriate latches. Corresponding lugs or indentations would then have to be provided on the base cup or base 70.

The diameter (D) and the height (h) of the integrated gas discharge lamp 5 shall hereinafter be defined largely independently of the geometry in order to be able to provide a simpler description. The height (h) of the integrated gas discharge lamp is taken to mean the maximal spacing of the reference plane, which will be discussed in more detail below, from the outer side of the base plate (74) facing away from the burner. The diameter (D) is taken to mean the longest section within the integrated gas discharge lamp, with the section being located within any plane, this plane extending parallel to the reference plane.

The following table shows some geometric sizes of various embodiments of the fourth embodiment of the gas discharge lamp 5 shown in FIG. 9:

| | Length or | | | |
|---|---|---|---|---|
| Diameter | height h | Volume | Weight | D/h |
| A. 50 W lamp | | | | |
| 100 | 35 | 275 | 510 | 2.86 |
| B. 35 W lamp | | | | |
| 100 | 25 | 196 | 178 | 4.00 |
| C. 25 W lamp, | | | | |
| standard variant | | | | |
| 70 | 25 | 99 | 139 | 2.80 |
| D. 18 W lamp, | | | | |
| superflat variant | | | | |
| 100 | 15 | 120 | 168 | 6.67 |
| E. 45 W lamp, | | | | |
| coffee tin variant | | | | |
| 40 | 50 | 63 | 52 | 0.80 |
| F. 7 W lamp, | | | | |
| for use in flashlight | | | | |
| 40 | 35 | 44 | 36 | 1.14 |

The electrical powers from 7 W to 50 W listed in the table of the different embodiments refer to the nominal electrical power of the gas discharge lamp burner. Different geometries and sizes of the identical gas discharge lamp burner are used here.

As can clearly be seen in FIG. 4, the lamp base of the integrated gas discharge lamp 5 according to the second and fourth embodiments have a hexagonal shape which provides several advantages. Firstly the integrated gas discharge lamp 5 is thus easy to grasp for inserting it at its intended location. Secondly the panel of the printed circuit board of the integrated overall operating electronics 930 can be configured in such a way that only little cutting waste occurs, making good cost efficiency possible. The flat design of the base means that a very short headlight can be formed, and this is particularly advantageous in modern motor vehicles. The point symmetrical hexagonal shape in this application enjoys all the advantages of a round shape but without exhibiting the drawbacks thereof.

As shown in'FIGS. 3 and 4, at one side of the base 70 of the lamp, contacts 210, 220 protrude radially out of the base with respect to the longitudinal axis of the gas discharge lamp burner 50. They are used to establish electrical contact between the integrated gas discharge lamp 5 and a headlight. These contacts are overmolded as part of a plastic injection molding process during production of the lamp base 70. This has the advantage that no special connector system is required but the water- and airtight encapsulation, as has already been described above, can still be ensured.

### Headlight Interface

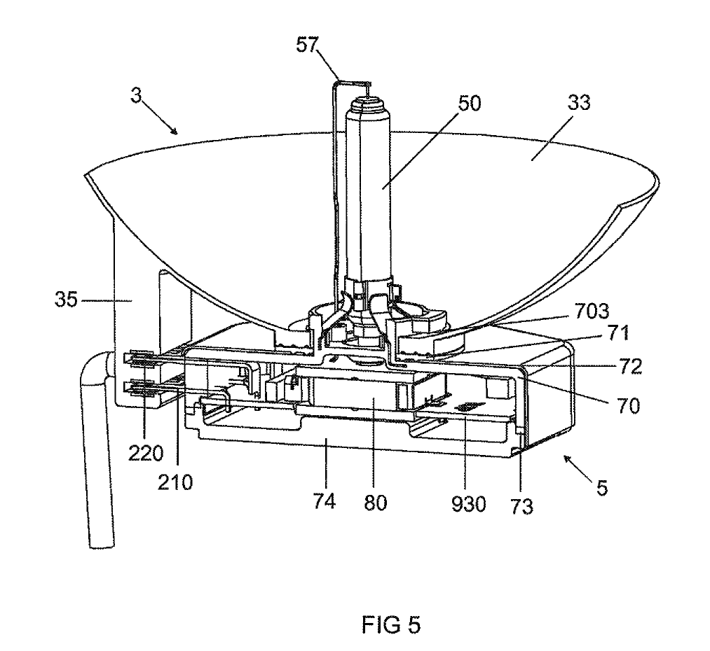

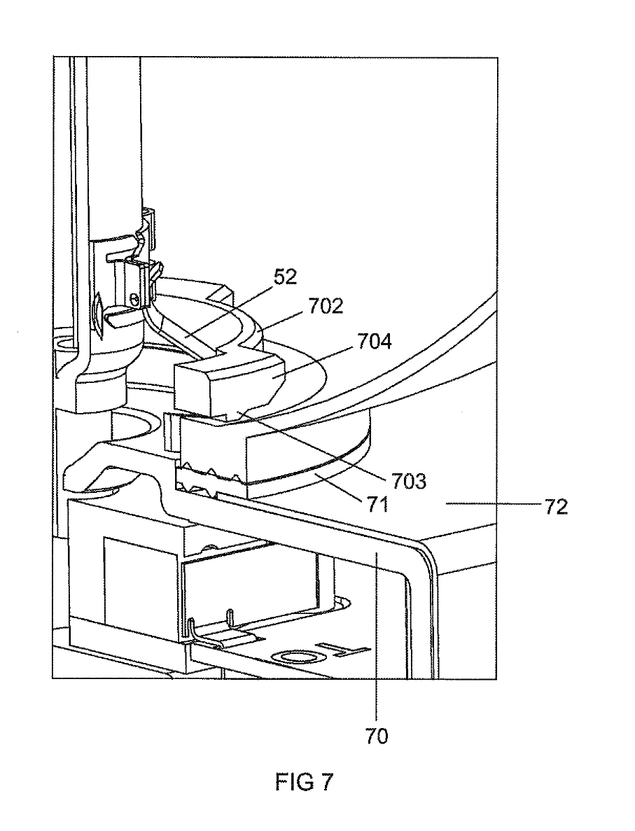

FIG. 5 shows the interaction between integrated gas discharge lamp 5 and headlight 3. The gas discharge lamp 5 in the second embodiment has a special electrical interface via which it is provided with electrical power. The electrical interface is designed in such a way that when the gas discharge lamp 5 is inserted into a headlight 3 it is electrically connected to the headlight 3 at the same time as being mechanically connected thereto. A similarly constructed interface is also used in modern halogen bulbs for car headlights and is sold for example by Osram under the name “Snap Lite”. If the integrated gas discharge lamp 5 is therefore inserted into a reflector or headlight, then during the process of insertion all mechanical and electrical contacts required for correct operation are connected to their corresponding counter contacts present in the headlight 3. At its interface with the headlight 3 the base 70 comprises knobs 703 issuing out of a reference ring 702 and defining a reference plane. FIG. 7 shows a detailed view. These three knobs rest on the corresponding counterpart of the headlight 3 when the integrated gas discharge lamp 5 is inserted. The electrodes or the discharge arc of the gas discharge lamp burner 50 are adjusted with respect to the reference plane during the manufacturing process of the integrated gas discharge lamp 5. The arc of the integrated gas discharge lamp 5 therefore adopts a defined position in the reflector when inserted into the headlight, allowing precise optical imaging. Insertion into the headlight takes place in the second embodiment according to FIGS. 3 and 4 by pushing the tongues 704 that laterally protrude from the reference ring through the base of a reflector 33 of the headlight 3. The integrated gas discharge lamp 5 is then rotated relative to the reflector 33, whereupon the knobs 703, which are provided on the base-side surface of the tongues 704, pull the integrated gas discharge lamp inward and at the end of the rotation latch in reference surfaces on the reflector base provided for this purpose. The sealing ring 71 is compressed in the process and tensions the system in such a way that the knobs 703 are pressed against the reference surfaces located in the reflector base. The position of the integrated gas discharge lamp 5, and therefore the discharge arc of the gas discharge lamp burner 50, is therefore precisely adjusted and fixed with respect to the reflector 33. The high repeat accuracy of the mechanical positioning of typically better than 0.1 mm in all three spatial directions of the described headlight interface allows an optically outstanding headlight system to be achieved. Such a headlight system can be used in a motor vehicle in particular since it is distinguished in the corresponding embodiment by a distinctive and well defined light/dark boundary.

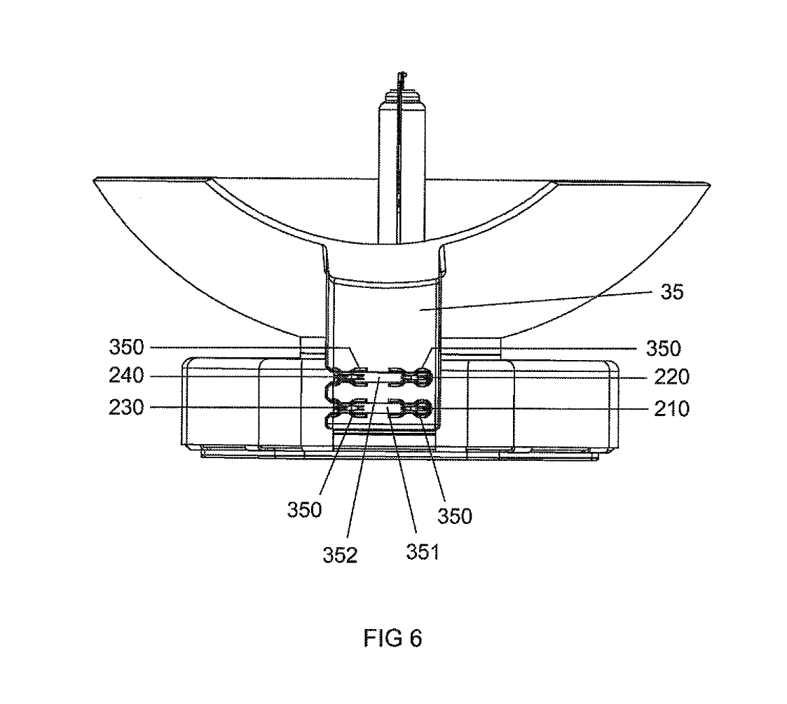

For this purpose a suitable headlight 3 has a light-guiding means in the form of a reflector 33, a receptacle for the integrated gas discharge lamp 5 and a carrier part 35, with a connecting element provided with counter contacts for the electrical contacts 210, 220, 230, 240 of the integrated gas discharge lamp 5 being arranged on the carrier part. The electrical contacts 210, 220, 230, 240 of the integrated gas discharge lamp 5 project out of the lamp base 70 radially with respect to the longitudinal axis of the gas discharge lamp burner 50. They are used to supply the overall operating electronics 930 with electrical energy. After mounting the integrated gas discharge lamp 5 in the headlight by way of an assembly process, which is substantially based on an insertion movement followed by a rotation to the right, its contacts 210, 220, 230, 240 are arranged in the slots 351, 352 of the connecting element 35, as can be seen in the detailed drawing of FIG. 6. These slots 351, 352 are the slots for the electrical counter contacts 350 pertaining to the contacts 210, 220, 230, 240 of the integrated gas discharge lamp 5. Consequently the connectors, provided with connecting cables, for contacting the integrated gas discharge lamp 5 in the headlight according to the prior art are omitted. In particular, when inserted into the headlight, the electrical contacts of the integrated gas discharge lamp 5 make direct contact with their counter contacts 350 of the connecting element on the carrier part 35. The mechanical stress on the electrical connections due to freely swinging cables is consequently reduced. Furthermore, the number of connecting cables required per headlight is reduced and therewith the risk of confusion during manufacture. In addition this measure also allows a higher level of automation when manufacturing the headlight as fewer cables have to be mounted by hand. Instead of providing all light sources in the headlight with power by means of a connector placed on the lamp base and provided with a connecting cable as previously according to the prior art, in the headlight according to the invention it is sufficient to connect existing electrical supply contacts of the headlight to the on-board electrical system to provide the integrated gas discharge lamp 5 with power. Supplying of the lamps present in the headlight by way of the supply contacts of the headlight is provided by fixed wiring in the headlight. The cabling of the headlight 3 or the integrated gas discharge lamp 5 is considerably simplified as a result.

The first embodiment of the lamp in FIGS. 1 and 2 shows a further variant of the mechanical adjustment. Here the knobs 703 are arranged on the side of the reference ring 702 that faces the gas discharge lamp burner 50. In this variant the knobs 703 come to rest on corresponding opposing surfaces on the back of the reflector to thus define the position of the integrated gas discharge lamp 5 with respect to the reflector 33. The integrated gas discharge lamp 5 is pressed from behind onto the reference surfaces of the reflector 33 in the process. However, this variant has the drawback that the position between the optically effective inside of the reflector and the reference surfaces on the back of the reflector have to be very accurately toleranced to achieve precise optical imaging.

The system of the headlight interface of the second embodiment is also suitable for attaining even more simplified cabling in modern bus systems. In addition to the two electrical contacts 210, 220 the integrated gas discharge lamp 5 therefore has further contacts 230, 240 via which communicate with the on-board electronics of the motor vehicle takes place. The connecting element 35 has two slots 351, 352 with two counter contacts each accordingly. In a further exemplary embodiment (not shown) there are only three electrical contacts on the lamp, two which are substantially used for supplying the electrical lamp power and a logic input, also called a remote enable pin, with whose help the lamp can be switched on and off virtually without power by the on-board electronics of the motor vehicle.

In addition to the advantage that confusion of electrical connections is ruled out, this “Snap Lite” interface has a further advantage: as a result of the fact that the lamp is only supplied with power when it is in its intended location in the headlight, the power supply line 57, facing away from the base, of the gas discharge lamp burner 50 can only be touched if the integrated gas discharge lamp 5 is definitely not operating. The level of safety when dealing with such a high pressure discharge lamp is consequently drastically increased. The simple installation of the integrated gas discharge lamp 5 in the headlight 3 means that the end customer is able to replace a lamp of this kind. The integrated gas discharge lamp 5 is consequently less expensive for the end customer because a garage does not have to found to change the lamp.

The ground connection of the lamp to the headlight housing is also achieved by inserting the integrated gas discharge lamp 5 into the reflector 33. This can be achieved, by way of example, by spring sheet metal strips secured to the reflector 33 and connected to the ground potential of the vehicle. When the lamp is inserted into the headlight the spring sheet metal strips touch the electrically conducting housing surface of the integrated gas discharge lamp 5 and establish an electrical connection between the vehicle ground and the internal ground or the ground shield of the integrated gas discharge lamp. This contacting can, by way of example, take place at the side wall or at the end of the housing 72. In the present case the ground connection takes place by means of the sealing ring 71 which is conductive. If the housing surface is not electrically conductive, or not completely electrically conductive, contacting of the spring sheet metal strips takes place at a contact surface on the housing surface of the integrated gas discharge lamp. This contact surface or these contact surfaces has/have an electrically conducting connection to the internal ground or the ground shield of the integrated gas discharge lamp.

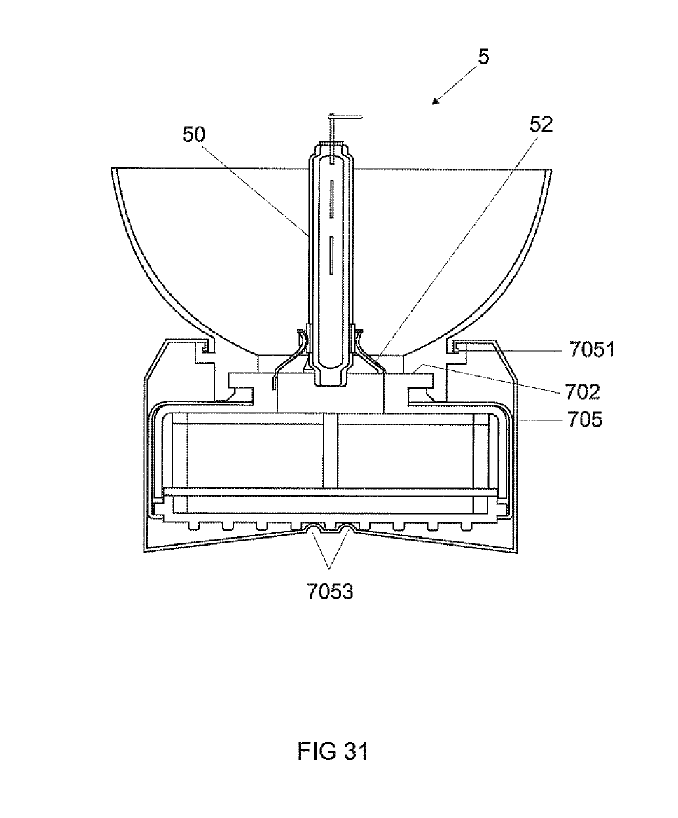

FIG. 31 shows a further fifth embodiment with a conventional interface to the headlight. Here the integrated gas discharge lamp 5 is pushed with the reference surface 702 onto a corresponding opposing surface of the headlight receptacle by means of a retaining clip 705. The integrated gas discharge lamp 5 is electrically connected to the headlight in a conventional manner. The retaining clip 705 ensures that with its reference surface 702 the integrated gas discharge lamp 5 is effectively connected to the receptacle in the headlight thus providing precise alignment of the electrodes in the optical system of the headlight. The electrodes 504 of the gas discharge burner lamp 50 of the integrated gas discharge lamp are adjusted with respect to the reference surface 702 during the manufacturing process of the integrated gas discharge lamp 5. The arc of the integrated gas discharge lamp 5 in the reflector therefore assumes a defined position when it is inserted into the headlight, and this allows precise optical imaging. The spring effect of the retaining clip 705 ensures this imaging even in the case of aggravated conditions such as vibrations, which can occur in a vehicle headlight. The retaining clip is in turn hooked into a groove 7051 on the headlight side which holds it securely but from which it can still be easily unhooked to change the lamp. At the bottom the retaining clip 705 engages with two bulges 7053 in the base plate 74. However, it is also conceivable for the retaining clip 705 to not have any bulges and therefore to rest on the ribs of the base plate. Simple and inexpensive connection to a headlight, which does not have any restrictions in relation to positioning accuracy in the optical system of the headlight, can be achieved with the fifth embodiment of the inventive gas discharge lamp 5.

### Ignition Transformer

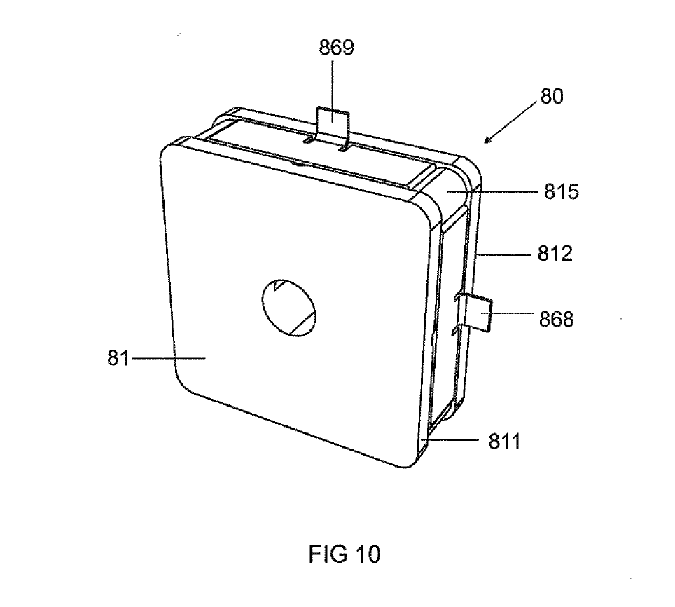

The construction of the ignition transformer 80 of the integrated gas discharge lamp 5 will be described below. FIG. 10 shows a perspective view of the ignition transformer 80 in a first embodiment in which the ignition transformer 80 has a square, flat shape. Other embodiments are conceivable, however, in which the ignition transformer 80 has a round, hexagonal, octagonal or another suitable shape. Further embodiments will be described below. The shape is hereby taken to mean the shape of the base area of the substantially prismatic external dimensions of the ignition transformer with the curves at the body edges being ignored. In the particularly advantageous embodiment shown here the prism has a low height, in particular a height which is less than ⅓ of the diagonals or the diameter of the geometry forming the base area.

The ignition transformer 80 comprises a ferrite core 81 which is composed of a first ferrite core half 811 and an identical second ferrite core half 812. At the sides the ignition transformer 80 comprises a plurality of outwardly pointing tongues 868, 869 which are used to mechanically secure the ignition transformer 80.

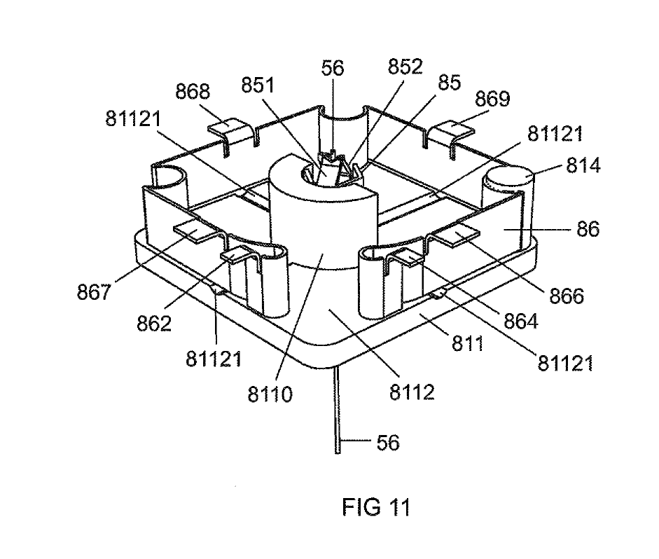

FIG. 11 shows a perspective view of the upper part of the ignition transformer in which the primary winding and the second ferrite core half 812 cannot be seen. The first ferrite core half 811 consists of a square side wall 8112 from which a half hollow cylinder 8110 protrudes centrally inward. The inside of the square side wall 8112 comprises inwardly extending elongate indentations 81121 on the side facing the winding. An impregnating varnish or a casting compound, into which the ignition transformer 80 is introduced following completion for high voltage insulation, can inwardly penetrate through these indentations into the ignition transformer 80 to uniformly wet all the turns of the ignition transformer 80.

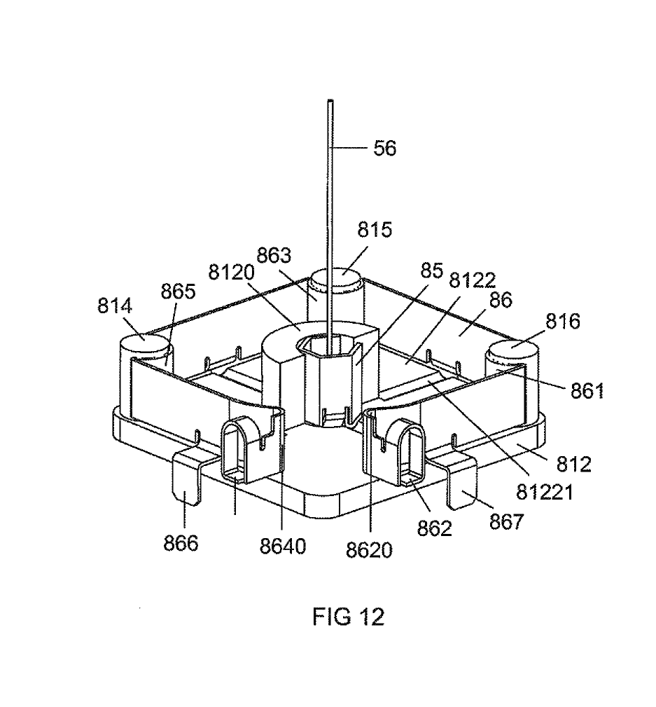

At the outer edge between the two ferrite core halves 811, 812 there is a primary winding 86 which consists of a stamped bent part formed from sheet metal. The sheet metal is preferably made from a non-ferrous metal such as copper, bronze or brass. The sheet metal is preferably elastically deformable and resilient. The primary winding 86 is substantially a long strip which extends on the outside between the two ferrite core halves 811 and 812. In a first variant the primary winding 86 passes over three corners of the ignition transformer 80 with just one turn, the fourth corner is open. The sheet metal strip of the primary winding 86 is therefore a three-quarter turn around the external contour of the ignition transformer and ends just before the fourth corner in each case. The sheet metal strip of the primary winding 86 comprises the tongues 866, 867, 868 and 869 already mentioned above, which are provided in the lateral direction of the sheet metal strip. The four tongues are used to mechanically secure the ignition transformer 80 and for this purpose they can, for example, be soldered to a printed circuit board of the ignition electronics 910 as a flat SMD tongue or soldering lug. The tongues can, however, also have an additional 90° bend, with the tongues then being pushed through the printed circuit board of the ignition electronics 910 and being clinched, twisted or soldered on the other side, as is shown in FIG. 12. The two ends of the sheet metal strip of the primary winding 86 are bent outward with a radius of about 180°, so the ends again point away from the fourth corner. In FIG. 12 the two ends are bent outward by about 90° and the radii are designated 8620 and 8640 respectively. Provided on each outer end of the sheet metal strip is a laterally protruding tongue 862, 864 which is used for electrical contacting. FIG. 12 shows an alternative embodiment of the two tongues 862, 864. Tensions in the connection between primary winding and printed circuit board, which can result due to variations in temperature, can be absorbed by the soft connection by means of the 180° radius of the two radii 8620 and 8640 respectively. The tongues are preferably soldered to the printed circuit board of the ignition electronics 910 like an SMD component. The soldered joint is not stressed by the described mechanical stresses due to the above-described 180° bend in the sheet metal strip and the risk of fracturing or fatigue in the soldered joint is very greatly reduced. The alternative embodiment of the tongues 862, 864 has a further 270° radius in the tongue itself which further reduces the mechanical stresses in the assembled state.

A contact body 85 is introduced into the center of the hollow cylindrical inner part of the ferrite core and this produces the electrical contact between the gas discharge burner lamp 50 and the inner end of the secondary winding 87 (not shown). The contact body 85 consists of a bent sheet metal part which is connected to the power supply line 56 of the gas discharge burner lamp 50 that is close to the base. At its end remote from the burner the contact body 85 has two roof areas 851, 852 for contacting the high pressure discharge lamp electrode. On two opposite sides of the end remote from the burner, the contact body 85 preferably has two roof areas 851, 852, which are inclined toward each other in a gabled manner and at the ends at which the two roof areas touch are shaped in such a way that a power supply wire 56 of the high pressure gas discharge lamp burner 50 is clamped so as to be centered. For this purpose the two roof areas 851 and 852, at the ends at which the two roof areas 851, 852 touch, are provided with a V-shaped contour. The contour can, however, also be round or be formed in another suitable way. For assembly the power supply wire 56 is pushed through the contact body 85, cut to a predetermined excess length and then preferably welded to the contact body 85 by means of a laser.

FIG. 12 shows a perspective view of the lower part of the ignition transformer. The figure shows inter alia the second ferrite core half 812 which has an identical shape to the first ferrite core half 811. It is also composed of a square side wall 8122, from which a half hollow cylinder 8120 protrudes centrally inward. The inside of the square side wall 8122 comprises inwardly extending elongate indentations 81221. The side of the contact body 85, with its hexagonal, open shape, close to the burner, and the power supply wire 56 passing through it, is visible in the figure. When the two halves are assembled a hollow cylinder is produced on the inside into which the contact body is introduced. After assembly the ferrite core 81 has the shape of a tape or film reel, except the external contour is not round but square with rounded corners.

At the first corner the ignition transformer comprises a first return ferrite 814. The second and third corners are also provided with a second return ferrite 815 and third return ferrite 816. The three return ferrites are held by the primary winding 86. For this purpose the sheet metal strip of the primary winding 86 comprises at the three corners cylindrical, inwardly pointing curves 861, 863 and 865 into which the return ferrites 814 to 816 are clamped. The three return ferrites 814-816 remain securely in their places during production due to the resiliently elastically deformable material. The return ferrites produce the magnetic yoke of the ignition transformer 80 via which the magnetic field lines are kept in the magnetic material, and therefore cannot cause any interference outside the ignition transformer. This significantly increases the efficiency of the ignition transformer, moreover, and in particular the level of achievable ignition voltage as well.

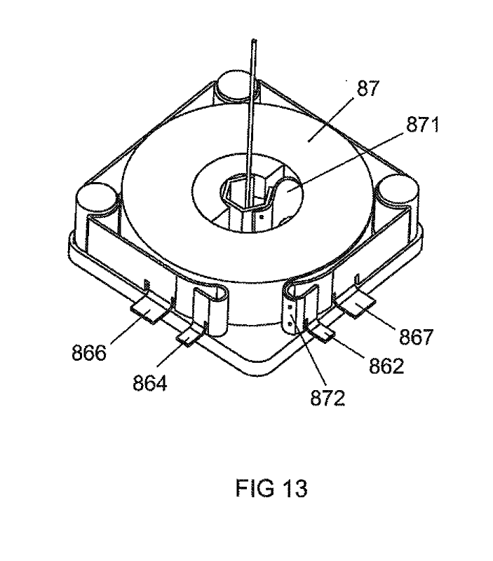

FIG. 13 shows a perspective view of the lower part of the ignition transformer 80 with visible secondary winding 87 as it is inserted into the second ferrite core half 812 of the ignition transformer 80. The secondary winding 87 consists of an insulated metal strip which is wound like a film with a predetermined number of turns onto the film reel-like ferrite core, wherein the high voltage-carrying end comes to rest on the inside, is fed through the central core of the film reel-like ferrite core and is connected in an electrically conducting manner to the contact body 85. The insulation can be provided on all sides of the metal strip but can also consist of an insulating film which is wound along with the metal strip. The insulating film is preferably wider than the metal strip to ensure an adequate insulation distance. The metal foil is wound with the insulating film in such a way that it comes to rest in the center of the insulating film. This produces a spiral-shaped gap in the winding body which after impregnation or casting with the impregnation varnish or casting compound is filled and thus brings about excellent insulation of the secondary winding 87.

The secondary winding 87 is connected at its inner, high voltage-carrying end 871 to the contact body 85. The outer low voltage-carrying end 872 of the secondary winding 87 is connected to the primary winding 86. The connections can be produced by soldering, welding or another suitable joining technique. In the present embodiment the connections are laser welded. For this purpose two spot welds are preferably applied per end which connect the two parts together in a secure and electrically conducting manner. The inner end 871 of the secondary winding 87 passes through the two hollow cylinder halves 8110, 8120 of the ferrite core in the process and is clamped by them. The outer end 872 of the secondary winding 87 is connected to the end of the primary winding 86 in such a way that the winding direction of the secondary winding 87 is opposed to the winding direction of the primary winding 86. Depending on the requirement the outer end of the secondary winding 87 can, however, also be connected to the outer end of the primary winding 86, so the winding direction of the primary and secondary windings is the same.

The diameter and the height of the ignition transformer 80, which is housed in the integrated gas discharge lamp 5, shall hereinafter largely be defined independently of its geometry and based on the dimensions of the ferrite core in order to be able to provide a simpler description. The height of the ignition transformer is taken to mean the spacing between the two outer surfaces of the two wide walls, which are remote from the winding in each case, and this approximately tallies with the sum of twice the thickness of a side wall and the winding width. The diameter of the ignition transformer 80 is hereinafter taken to mean the longest section within one of the two side walls, irrespective of the shape of the side walls, the section lying within any plane and this plane extending parallel to the outer surface of the respective side wall.

In a particularly advantageous embodiment the ferrite core of the ignition transformer has a height of 8 mm and a diameter of 26 mm. The side walls have a diameter of 26 mm and a thickness of 2 mm and the central core a diameter of 11.5 mm with a height of 6 mm. The secondary winding consist of 42 turns of a kapton foil with a width of 5.5 mm and a thickness of 55 μm to which a copper layer that is 4 mm wide and 35 μm thick and centered in the longitudinal direction is applied. In a further particularly advantageous embodiment the secondary winding is wound from two separate foils placed one on top of the other, a 75 μm thick copper foil and a 50 μm thick kapton foil being used. In both embodiments the secondary winding is connected in an electrically conducting manner to the primary winding comprising one turn, the primary winding being activated by a pulse generating unit comprising a 800 V spark gap.

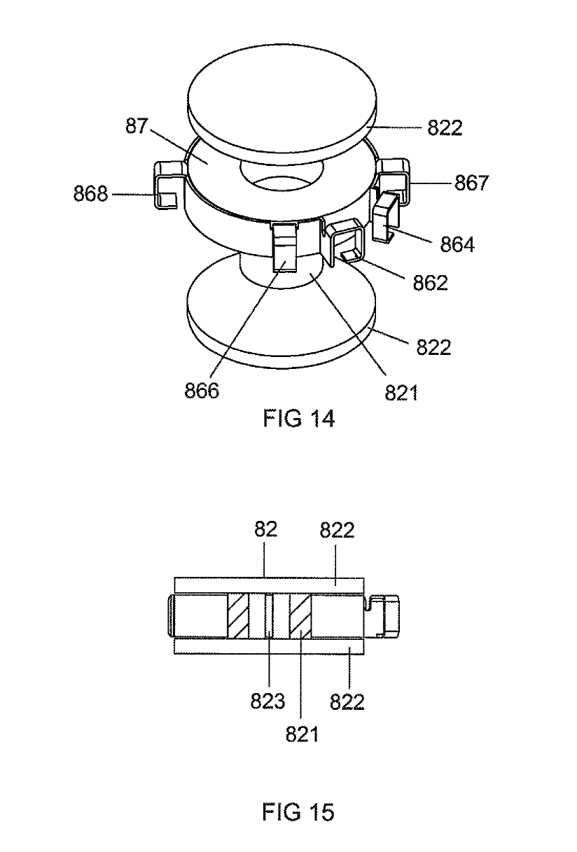

FIG. 14 shows an exploded view of the ignition transformer 80 in a second embodiment. As the second embodiment is similar to the first embodiment of the ignition transformer 80 only the differences from the first embodiment will be described hereinafter. The ignition transformer 80 in the second embodiment has a round shape, similar to the case of a film reel. The return ferrites 814 to 816 are omitted due to the round shape and the primary winding 86 has a simpler shape. The laterally protruding tongues for the mechanical securing of the transformer are designed here as SMD tongues which have a 270° bend to protect the soldered joints against excessive mechanical stresses. The two tongues 862, 864 for electrical contacting are designed in the same way and are radially arranged on the circumference of the ignition transformer 80. The ferrite core 82 of the second embodiment has a three-part design. It comprises a hollow cylindrical central core 821 which is finished at its two ends by round plates 822. The round plates 822 come to rest centrally on the hollow cylinder 821 thus producing the above-described film reel shape. The hollow cylinder comprises a slot 823 (not visible in the figure) in order to be able to pass the inner end of the secondary winding 87 into the interior of the hollow cylinder.

FIG. 15 shows a sectional view of the second embodiment of the ignition transformer 80. Here the construction of the ferrite core 81 can be readily comprehended. Also identifiable in this view is the slot 823, through which the inner end of the secondary winding 87 is passed.

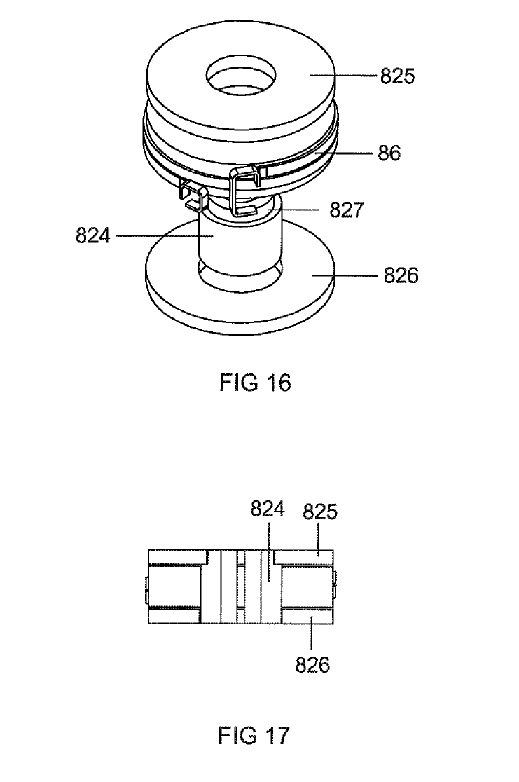

FIG. 16 shows an exploded view of the ignition transformer in a third round embodiment with two-turn primary winding. As the third embodiment is very similar to the second embodiment of the ignition transformer 80, only the differences from the second embodiment will be described hereinafter. In the third embodiment the ignition transformer 80 comprises a primary winding with two turns. The metal strip of the primary winding 86 therefore goes around the ignition transformer barely twice. Tongues for the electrical contacting of the ignition transformer 80 are again provided at the two ends and are designed as SMD variants. The tongues for mechanical securing of the ignition transformer 80 are missing in this embodiment. The ignition transformer 80 therefore has to be mechanically fixed in some other way. This can be brought about for example by clamping the ignition transformer 80, as is indicated in FIG. 3. The ignition transformer 80 is clamped between the base 70 and the base plate 74 here. For this purpose the base plate 74 comprises a base plate dome 741, an elevation on the base plate which clamps the ignition transformer 80 in the fitted state. The advantage of this construction is the good heat dissipation of the ignition transformer 80. This can become very hot during operation because it is sits very close to the gas discharge lamp burner 50 of the integrated gas discharge lamp 5. Some of the heat, which is introduced by the gas discharge lamp burner 50 into the ignition transformer 80, can be dissipated again by the highly thermally conductive base plate 74 and the ignition transformer 80 can be effectively cooled.

FIG. 17 shows a sectional view of the ignition transformer 80 in a third round embodiment with two-turn primary winding. This sectional view again shows the core construction of the ferrite core 82 very clearly. As in the second embodiment the ferrite core 82 is constructed from three parts, a central core 824 and two plates 825, 826. The central core 824 is also hollow cylindrical and at one end has a shoulder 827 which engages in a round cutout of the first plate 825 and fixes it on the central core 824. A second plate 826 also has a round cutout whose internal radius matches the external radius of the central core 824. Following assembly of the secondary and primary windings this plate is inserted on the central core and fixed thereby. The plate is inserted to the extent that it comes to rest on the secondary winding to achieve an optimum magnetic flux in the ignition transformer 80.

### Asymmetrical Ignition Pulse

The mode of operation of the ignition device of the integrated gas discharge lamp 5 will be described below.

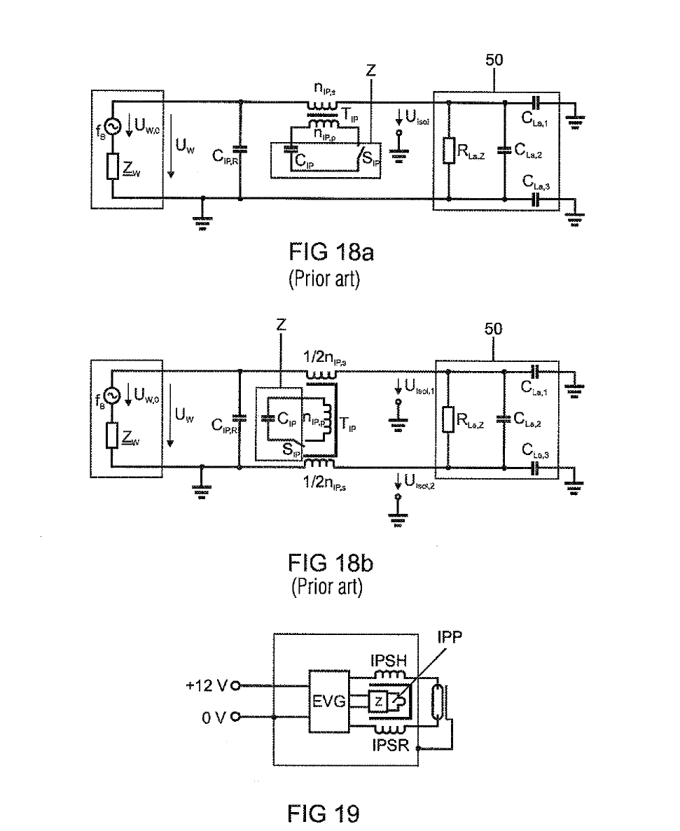

FIG. 18a shows the schematic circuit diagram of an asymmetrical pulse ignition device according to the prior art. With an asymmetrical ignition device the ignition transformer T_{IP} is wired into one of the supply lines of the gas discharge lamp burner 50, which is shown here as an equivalent circuit diagram. This results in an ignition pulse, which generates a voltage only in one “direction” from the ground reference potential, which is usually connected to the other supply line of the gas discharge lamp burner. In other words, either a positive voltage pulse is generated with respect to the ground reference potential or a negative voltage pulse is generated with respect to the ground reference potential. The mode of operation of an asymmetrical pulse ignition device is largely known and shall not be described further here. The asymmetrical voltage is well suited to lamps inserted into bases on one side because the ignition voltage is only applied to one of the two gas discharge lamp burner electrodes. The electrode close to the base is regularly chosen for this because it cannot be touched and therefore does not present a potential threat to humans in the event of improper use. No voltage that is dangerous to humans is applied to return conductors that are conventionally openly routed. A lamp operated with an asymmetrical ignition device therefore ensures a certain level of safety. However, the asymmetrical ignition device has the drawback of applying all of the ignition voltage to one gas discharge lamp electrode. The losses due to corona discharges increase therefore, as do other effects due to the high voltage. This means that only some of the generated ignition voltage is actually applied to the gas discharge lamp burner 50. A higher ignition voltage than necessary therefore has to be generated, and this is laborious and expensive.

FIG. 18b shows the schematic circuit diagram of a symmetrical pulse ignition device according to the prior art. The symmetrical pulse ignition device comprises an ignition transformer T_{IP} which has two secondary windings which are magnetically coupled together with the primary winding. The two secondary windings are oriented in such a way that the generated voltage of the two secondary windings adds up on the lamp. The voltage is therefore distributed approximately equally among the two gas discharge lamp electrodes.

As already mentioned, the losses due to corona discharges and other parasitic effects are therefore reduced. The cause of the generally higher ignition voltage with the symmetrical pulse ignition is only obvious on closer examination of the parasitic capacitances. For this purpose the lamp equivalent circuit diagram of the gas discharge lamp burner 50 in FIG. 18b will be considered. A large, if not the largest, portion of the parasitic lamp capacitance C_{La} is not caused by the lamp itself but by the connection between lamp and ignition unit, for example due to the lamp wires. However, these have parasitic capacitances between conductors and the environment in addition to those from conductor to conductor. If, by way of simplification, a description with concentrated energy stores is assumed, the parasitic capacitances between the two conductors or the two gas discharge lamp electrodes can be combined to C_{La, 2}, as shown in FIG. 18b. The parasitic capacitances present between conductor and environment in each case are modeled by C_{La, 1} and C_{La, 3} respectively. The potential of the environment, for example of the housing, will be regarded as spatially constant hereinafter and represented by the ground symbol even if this does not have to tally with the PE or PEN in the sense of a low voltage network. Furthermore, a symmetrical construction and therewith C_{La, 1}=C_{La, 3} should be assumed. The parasitic lamp capacitance according to the expanded equivalent circuit diagram is C_{La, 2}+½C_{La, 1}.

The difference between the asymmetrical pulse ignition and the symmetrical pulse ignition becomes clear if it is taken into account that the transformer and the ignition unit have parasitic capacitances with respect to the environment. These are sometimes intentionally increased (for example line filter) and are generally significantly greater than the parasitic capacitances of the lamp with respect to the environment considered above and therefore, by way of simplification, electronics at ambient potential can be assumed for a consideration of the ignition. By ignoring the voltage UW, C_{La, 1} and C_{La, 2} are therefore to be charged onto the ignition voltage in the case of asymmetrical ignition, whereas with symmetrical ignition C_{La, 2} is to be charged onto the ignition voltage and C_{La, 1} as well as C_{La, 3} are to be charged onto half the ignition voltage respectively. Assuming a symmetrical construction, i.e. C_{La, 1}=C_{La, 3}, less energy is therefore required for charging the parasitic capacitances in the case of the symmetrical pulse ignition than for the asymmetrical variant. In an extreme case C_{La, 1}=C_{La, 3}>>C_{La, 2} the ignition unit according to FIG. 18a has to provide almost twice the energy compared with that according to FIG. 18b.

A further advantage of the symmetrical ignition lies in the lower insulation strength required with respect to the environment because the voltages that occur U_{Isol, 1} and U_{Isol, 2} are only half the value of the voltage U_{Isol} in the case of asymmetrical ignition. At the same time this demonstrates the drawback of symmetrical pulse ignition and the reason why it often cannot be used: in the case of symmetrical ignition both lamp connections carry high voltage, and for safety reasons this is often inadmissible because in many lamp or base constructions one of the two lamp connections, conventionally the one remote from the lamp, which is then called the “lamp return conductor”, can be touched.

This shows that the symmetrical ignition method is optimally suited to gas discharge lamps that have bases on two sides and which are already symmetrical in terms of mechanical construction. With a gas discharge lamp with a base on one side there is, as already mentioned, the problem of ignition voltage which is applied to the open gas discharge lamp electrode remote from the base which can be accessed by the user. A further problem is the voltage applied to the gas discharge lamp electrode remote from the base with respect to the potential of the reflector. The reflector in which the gas discharge lamp is fitted is conventionally grounded. Therefore at the instant of ignition a high voltage is applied between the return conductor of the electrode remote from the base and the reflector. This can lead to flashovers on the reflector, which result in malfunctions. For these reasons symmetrical ignition is not suitable for gas discharge lamps with a base on one side.

It should also be noted that the insulation expenditure increases non-linearly with the voltage to be insulated. As a result of non-linear effects in insulating materials the spacing between two conductors must typically be more than doubled if the voltage is doubled in order not to create a flashover/breakdown.

In addition to the purely capacitive behavior, considered above, of the environment or the insulating materials involved, above a certain voltage or the resulting field strengths in the insulating materials and at their boundary surfaces, an active power transformation in the insulating materials, for example due to corona discharges, partial discharges, etc., can no longer be ignored. In the above equivalent circuit diagrams additional non-linear resistances should be added parallel to the capacitances. Symmetrical pulse ignition should be preferred over the asymmetrical from this aspect as well.

Finally, the observation should be mentioned that above a certain voltage stress of the insulating material the latter ages considerably more quickly and therefore in the case of a slight voltage reduction a much increased lifetime can already be anticipated.

Asymmetrical pulse ignition, as can be seen in a schematic view in FIG. 19, constitutes a good compromise which combines the advantages of both ignition methods. It has a similar construction to symmetrical ignition but the two secondary windings have a different number of turns. The drawback of the symmetrical ignition method is primarily that accidental touching of the return conductor during ignition and therewith touching of a metal part carrying a high voltage by the user cannot be ruled out. With the integrated gas discharge lamp 5, which has the above-described headlight interface according to FIG. 5, this can be ruled out because the electronic devices are only supplied with voltage on insertion into the headlight. With an intact headlight it is therefore not possible to touch the return conductor of the electrode remote from the base when it is carrying voltage. As already mentioned above, symmetrical ignition is not possible here either because flashovers must be feared on the conventionally grounded reflector. Asymmetrical ignition is therefore proposed which, for example, gives of the ignition voltage to the electrode close the base and, for example, ¾ of the ignition voltage to the electrode remote from the base. The exact voltage ratio between the electrodes of the gas discharge lamp burner 50, i.e. that of the first lamp electrode close to the base and that of the second lamp electrode remote from the base, depends on many factors, the lamp size and the base construction. The voltage ratio between the first lamp electrode close to the base and the second lamp electrode remote from the base can range from 22:1 to 5:4. Voltages of 2.8 kV are preferably generated by way of the return conductor secondary winding IPSR of the ignition transformer T_{IP} and voltages of 23.17 kV are preferably generated by way of the forward conductor secondary winding IPSH of the ignition transformer T_{IP}. Preferred transformation ratios therefore result between the two secondary windings that are not equal to 1, namely n_{IPSR}:n_{IPSH}=2:23 . . . 8:17. This can also be expressed as equation n_{IPSR}=0.04 . . . 0.8*n_{IPSH}. The construction is therefore similar to that of a symmetrical igniter but the secondary windings are not uniformly distributed.

The number of primary windings nₚ of the ignition transformer T_{IP} is preferably between 1 and 4, the sum of the number of turns of the two secondary windings IPSH and IPSR is preferably between 40 and 380.

The pulse ignition unit Z in FIG. 19 is largely known from the prior art and will therefore not be described in detail here. It consists of at least one capacitor which is wired via a switching element to the primary winding of the ignition transformer. A switching element with a nominal triggering voltage between 350 V and 1300 V is preferably used. This can be a switching spark gap or a thyristor with corresponding control circuit. In the present first embodiment the ignition transformer T_{IP} has a transformation ratio n_{Ipp}:n_{IPSR}:n_{IPSH} of 1:50:150 turns which is operated with an ignition unit Z based on a 400 V spark gap, i.e. with a spark gap having a nominal triggering voltage of 400 V. The ignition transformer T_{IP} delivers a peak voltage of +5 kV to ground at the electrode of the gas discharge lamp burner 50 remote from the base and a peak voltage of −15 kV to ground at the electrode of the gas discharge lamp burner 50 close to the base.

In a further second embodiment the ignition transformer is designed with a transformation ratio of 3:50:100 turns and is operated with an ignition unit Z based on a 800 V spark gap. This delivers a peak voltage of −8 kV to ground at the electrode of the gas discharge lamp burner 50 remote from the base and a peak voltage of +16 kV to ground at the electrode of the gas discharge lamp burner 50 close to the base.

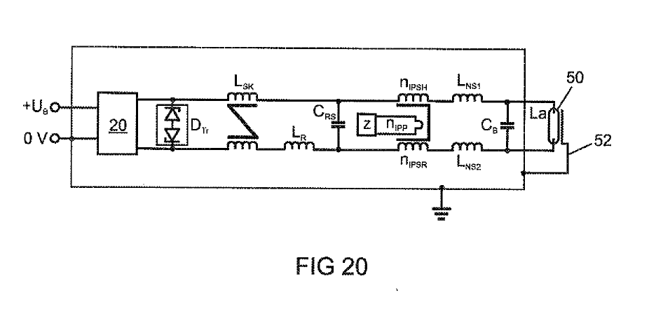

FIG. 20 shows the schematic circuit diagram of an expanded circuit of the integrated gas discharge lamp 5. Here one or two non-saturating chokes L_{NS1} and L_{NS2} are each wired between the high voltage-carrying end of a secondary winding respectively and the respective burner connection to prevent interference pulses with high voltage peaks (what are known as glitches). Inductance values of 0.5 uH to 25 uH, preferably 1 uH to 8 uH, are used. A high voltage-resistant capacitor C_{B} (what is known as a “burner capacitor”) can also be wired directly parallel to the gas discharge lamp burner and therefore between the gas discharge lamp burner and the non-saturating chokes. This conventionally has a capacitance of less than 22 pF in order not to dampen the ignition pulse excessively. It preferably has a capacitance of between 3 pF and 15 pF. The capacitor can constructively be implemented by an appropriate arrangement and design of the overmolded lamp power supply lines, for example in the form of plates. The capacitor has two positive effects: firstly it is advantageous for the EMC behavior of the lamp because high frequency interference which is generated by the lamp is short circuited directly where it is produced and secondly it ensures a low-resistance breakdown of the burner, and this facilitates takeover by the operating circuit 20 in particular.

A completion of the pulse igniter with respect to the electronic ballast (EB), which has a very low impedance, is achieved by means of a yoke capacitor C_{RS} with a capacitance value which is preferably between 68 pF and 22 nF for the very fast pulse generated by the ignition transformer T_{IP}. The high voltage ignition pulses generated are consequently fully applied to the burner in a very good approximation. The yoke capacitor C_{RS}, together with a return conductor choke L_{R}, forms a low-pass filter. This counteracts electromagnetic interference and protects the EB output against inadmissibly high voltages. The expanded circuit also comprises a current-compensated choke L_{SK} which also counteracts electromagnetic interference. A suppressor diode DTr, also called a clamp diode, limits the voltage produced at the operating circuit 20 owing to the ignition process, thereby protecting the output of the operating circuit 20.

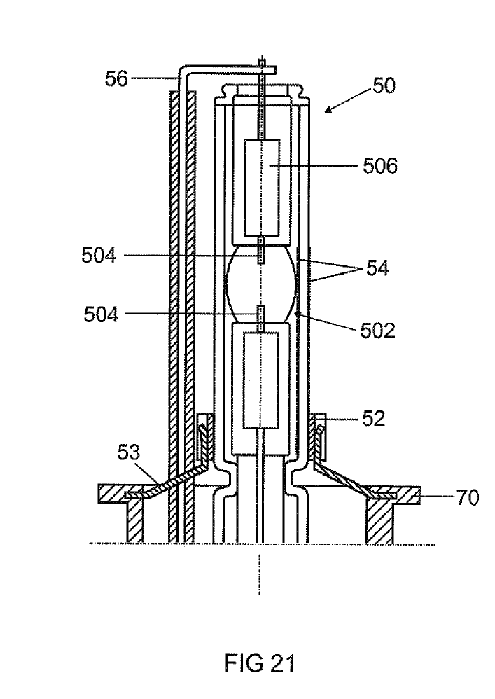

The gas discharge lamp burner 50 of the integrated gas discharge lamp 5 is secured by means of a metal clip 52 and four retaining plates 53 to the base 70 (see for example FIG. 1). As already indicated in FIG. 20, this metal clip 52 is accordingly grounded, i.e. with an integrated gas discharge lamp for cars grounded for example to the car body. A flashover from the metal clip to the headlight is reliably prevented due to the grounding of the metal clip because both parts are at the same potential even during ignition. A particularly good capacitive coupling to an auxiliary ignition coating on the gas discharge lamp burner vessel is also produced by the grounding of the metal clip. Such auxiliary ignition coatings are often applied in the case of high pressure discharge lamp burners to reduce the high ignition voltages. This measure increases the ignition voltage-reducing property of the auxiliary ignition coating on the gas discharge lamp burner vessel. It is particularly advantageous if the capacitive effect of the metal clip on the gas discharge lamp burner (optionally including its auxiliary ignition coating) is increased. For this purpose further electrically conducting parts are galvanically or capacitively coupled to the metal clip. This produces a type of “third electrode” which consists of a plurality of “individual electrodes coupled to each other” and is grounded at one side. By way of example this third electrode can, in addition to the metal clip, also comprise a metallic coating 54 on the outer bulb, as is indicated in FIG. 21. The coating can be applied to the outside and/or inside of the outer bulb. The coating consists of electrically conductive, for example metallic, material and is preferably applied in a strip parallel to the return conductor. The metallic coating 54 consequently does not become visible and, moreover, a minimal spacing, and therewith a maximum coupling capacitance to the auxiliary ignition coating on the burner vessel, results. The coating on the outer bulb can be capacitively or galvanically coupled to the metal clip. For a galvanic coupling it is particularly advantageous if the outer coating is electrically contacted with the metal clip by fixing the burner in the metal clip, and this can be achieved without additional expenditure by way of a common assembly technique according to the prior art. The coating preferably extends over 1% to 20% of the outer bulb circumference.

The positive effect of the grounded metal clip on the ignition voltage of a gas discharge lamp is produced by the following physical connection: as a result of the fact that in the case of a grounded metal clip and an asymmetrical pulse ignition a high voltage is applied between the metal clip and the two gas discharge lamp electrodes, a dielectrically impeded discharge is promoted in the outer bulb in the vicinity of both gas discharge lamp electrodes. The dielectrically impeded discharge in the outer bulb promotes a sparkover in the burner vessel. This is promoted by the UV light which is produced during the dielectrically impeded discharge and is barely absorbed by the burner vessel and promotes the production of free charge carriers at the electrodes and in the discharge chamber and therefore reduces the ignition voltage.

The metal clips and the reference plane to the reflector of the integrated gas discharge lamp 5 can consist of a metal part which has appropriate armatures, which are overmolded with plastic and ensure a good mechanical connection to the base 70. The metal clips are then automatically grounded by inserting the lamp into the reflector or rather in the headlight. This makes the reference plan accordingly more robust with respect to mechanical wear, and this is advantageous, due to the increased weight of an integrated gas discharge lamp 5. The embodiment according to the prior art provides only one plastic injection molded part as a reference plane.

In a preferred embodiment of the integrated gas discharge lamp 5 the base consists of two parts. A first part with a gas discharge lamp burner 50 that has already been adjusted and which is embedded by means of the metal clip 52 and the retaining plates 53 in a base made of plastic which, as described above, comprises a metal-reinforced reference plane. This first part is connected to a second part which contains the ignition and operating electronics. The connections for the lamp and the power supply lines can be provided by welding, soldering or by a mechanical connection such as a plug-in contact or an insulation displacement contact.

FIG. 21 shows a gas discharge lamp burner 50 which is described below. The gas discharge lamp burner 50 is preferably a mercury-free gas discharge lamp burner although a mercury-containing gas discharge lamp burner 50 may also be used. The gas discharge lamp burner 50 accommodates a gas-tight, sealed discharge vessel 502 in which electrodes 504 and a ionizable filling for producing a gas discharge are enclosed, the ionizable filling preferably being formed as a mercury-free filling comprising xenon and halides of the metals sodium, scandium, zinc and indium, and the weight ratio of the zinc and indium halides is in the range from 20 to 100, preferably 50, and the cold filling pressure of the xenon gas is in the range from 1.3 megapascals to 1.8 megapascals. It has been found that the decrease in the light flux over the operating time of the gas discharge lamp burner 50 and the increase in the burning voltage of the gas discharge lamp burner 50 over its operating time can consequently be reduced. In other words, compared with a gas discharge lamp burner according to the prior art, the gas discharge lamp burner 50 has improved light flux maintenance and has a longer lifetime due to the lower burning voltage increase over the operating time. Over its operating time the gas discharge lamp burner 50 also exhibits only a slight shift in the chromaticity coordinate of the light emitted by it. In particular the chromaticity coordinate shifts only within the limits allowed in accordance with ECE Rule 99. Both the comparatively high cold filling pressure of the xenon and the comparatively high percentage by weight of the zinc halides make a significant contribution to the adjustment of the burning voltage of the gas discharge lamp burner 50, i.e. the voltage which is adjusted across the discharge gap of the gas discharge lamp burner 50 after the end of the ignition phase, in the more or less stationary operating state. The indium halides are represented in such a small percentage by weight that they do contribute to the adjustment of the chromaticity coordinate of the light emitted by the gas discharge lamp burner 50 but do not make any significant contribution to the adjustment of the burning voltage of the gas discharge lamp burner 50. Like the halides of sodium and scandium, the indium halides are primarily used in the gas discharge lamp burner 50 for light emission.

The percentage by weight of the zinc halides advantageously lies in a range from 0.88 micrograms to 2.67 micrograms per 1 mm³ discharge vessel volume and the percentage by weight of the indium halides lies in a range from 0.026 micrograms to 0.089 micrograms per 1 mm³ discharge vessel volume. Iodides, bromides or chlorides may be used as halides.

The percentage by weight of the sodium halides advantageously lies in a range from 6.6 micrograms to 13.3 micrograms per 1 mm³ discharge vessel volume and the percentage by weight of scandium halides lies in a range from 4.4 micrograms to 11.1 micrograms per 1 mm³ of discharge vessel volume to ensure that the gas discharge lamp burner 50 generates white light with a color temperature of about 4,000 Kelvin and the chromaticity coordinate remains in the range of white light, preferably in narrow limits, throughout the lifetime of the gas discharge lamp burner 50. With a lower percentage by weight the sodium losses (caused by diffusion through the vessel wall of the discharge vessel) and scandium losses (caused by chemical reaction with the quartz glass of the discharge vessel) can no longer be compensated and with a higher percentage by weight the chromaticity coordinate and color temperature are changed.

The volume of the discharge vessel is advantageously less than 23 mm³ to come as close as possible to the ideal of a point light source. For use as a light source in a vehicle headlight or another optical system, the light-emitting part of the discharge vessel 502, i.e. the discharge chamber with the electrodes enclosed therein, should have the smallest dimensions possible. Ideally the light source should be punctiform in order to be able to arrange it in the focal point of an optical imaging system. The inventive high pressure discharge lamp 5 comes closer to this ideal than a high pressure discharge lamp according to the prior art because it preferably has a discharge vessel 502 with a smaller volume. The volume of the discharge vessel 502 of the high pressure discharge lamp 5 therefore advantageously lies in the range of greater than or equal to 10 mm³ to less than 26 mm³.

The spacing between the electrodes 504 of the gas discharge lamp burner is preferably less than five millimeters to be able to come as close as possible to the ideal of a point light source. For use as a light source in a motor vehicle headlight the electrode spacing is preferably 3.5 millimeters. The gas discharge lamp burner 50 is therefore optimally adjusted to the imaging conditions in the vehicle headlight.

The thickness or diameter of the electrodes 502 of the gas discharge lamp burner is advantageously in a range from 0.20 millimeters to 0.36 millimeters. Electrodes with a thickness in this value range can still be sufficiently securely embedded in the quartz glass of the discharge vessel and at the same time have sufficient ampacity, which is particularly significant during what is referred to as the start-up phase of the high pressure discharge lamp, during which it is operated at 3 to 5 times its nominal power and its nominal current. In the case of thinner electrodes sufficient ampacity would no longer be ensured in the case of the present embodiment with mercury-free filling, and in the case of thicker electrodes 504 there would be the risk of crack formation in the discharge vessel caused by the occurrence of mechanical stresses due to the very different thermal expansion coefficients of the discharge vessel material, which is quartz glass, and the electrode material, which is tungsten or tungsten doped with thorium or thorium oxide.

The electrodes are each connected to a molybdenum foil 506 embedded in the material of the discharge vessel and which allows gas-tight current feedthrough and the smallest spacing of the respective molybdenum foil 506 from the end, projecting into the interior of the discharge vessel 502, of the electrode connected to it is advantageously at least 4.5 mm, to ensure the largest possible spacing between the respective molybdenum foil 506 and the gas discharge starting at the electrode tips projecting into the discharge vessel 502. This comparatively large minimum spacing, caused as a result, between the molybdenum foils 506 and the gas discharge has the advantage that the molybdenum foils 506 are exposed to less thermal stress and a lower risk of corrosion due to the halogens in the halogen compounds of the ionizable filling.

### Frequency Adjustment

A method for avoiding flicker or jitter phenomena will be described below which the operating electronics of the integrated gas discharge lamp 5 carries out.

The gas discharge lamps being considered here must be operated with AC which is primarily generated by the operating electronics 920. This AC can be a high frequency AC, in particular with a frequency above the acoustic resonances that occur in gas discharge lamps, and this corresponds to a frequency of the lamp current of above about 1 MHz in the case of the lamps being considered here. However, low frequency square-wave operation is conventionally used and this will be considered below.

When incorrectly operated, gas discharge lamps, in particular high pressure discharge lamps, basically tend to break the arc in the event of a change in the direction of the lamp current, what is known as commutation, which can be attributed to the temperature of the electrodes being too low. High pressure discharge lamps are conventionally operated with a low frequency square wave current, and this is also called “intermittent DC operation”. In this case a substantially square wave current with a frequency of conventionally 100 Hz up to a few kHz is applied to the lamp. With every changeover between positive and negative driving voltage, which is substantially provided by the operating electronics, the lamp current commutates, and this entails a brief period at zero for the lamp current. This operation ensures that the electrodes of the lamp are uniformly loaded despite more or less DC operation.

The arc onset, i.e. the onset of the arc on the electrode, is basically a problem during operation of a gas discharge lamp with AC. With AC operation the cathode becomes an anode during commutation and, conversely, an anode becomes a cathode. Due to the principle the cathode-anode transition is relatively non-problematic because the temperature of the electrode has approximately no effect on its anodic operation. In the case of the anode-cathode transition the ability of the electrode to supply a sufficiently high current is dependent on its temperature. If this is too low the arc changes during commutation, usually after the zero crossing, from a punctiform arc onset mode to a diffuse arc onset mode. This change is accompanied by an often visible dip in light emission, and this may be perceived as flicker.

The lamp is therefore expediently operated in punctiform arc onset mode because the arc onset is very small in this case and therefore very hot. The consequence of this is that, owing to the higher temperature, less voltage is required at the small onset point to be able to supply sufficient current.

The procedure in which the polarity of the driving voltage of the gas discharge lamp burner 50 changes and at which there is therefore a strong change in current or voltage will hereinafter be considered as commutation. With a substantially symmetrical mode of operation of the lamp the voltage or current zero crossing is in the middle of the commutation time. It should be noted in this regard that voltage commutation conventionally always proceeds more quickly than current commutation.

From ‘The boundary layers of ac-arcs at HID-electrodes: phase resolved electrical measurements and optical observations’, O. Langenscheidt et al., J. Phys D 40 (2007), pages 415-431 it is known that with a cold electrode and diffuse arc onset the voltage after commutation initially increases because the electrode which is too cold can only supply the required current by way of a higher voltage. If the device for operating the gas discharge lamp cannot supply this voltage then the above-mentioned flicker occurs.

The problem of the changing arc onset mode applies primarily to gas discharge lamps which have comparatively large electrodes compared with similar lamps with the same nominal power. Lamps are then typically operated with an overload if “immediate light” is required, as, for example, in the case of xenon discharge lamps in the automotive sector in which, owing to the legal requirements, 80% of the light output must be achieved after four seconds. During what is referred to as a “quick-start”, also called a start-up phase, these lamps are operated at a much higher power than their nominal power to fulfill the applicable automotive standards or regulations. The electrode is therefore dimensioned for the high starting power but is too large with respect to the normal operating state. As the electrode is now mainly heated by the lamp current flowing through it, the problem of flicker primarily occurs in aging gas discharge lamps whose burning voltage is increased at the end of their lifetime. Due to the increased burning voltage a smaller lamp current flows because the operating electronics keep the lamp power constant during stationary lamp operation by means of regulation, for which reason the electrodes of the gas discharge lamp are no longer sufficiently heated at the end of their lifetime.

With an integrated gas discharge lamp an advantage accordingly lies in the fact that the operating electronics are inseparably connected to the gas discharge lamp burner, so the previous burning time, also called the cumulative burning time tₖ, which results by totaling all periods during which the gas discharge lamp burner was operated, irrespective of the periods in between in which the gas discharge lamp burner was not operated, can easily be determined by the operating electronics. This determination can, by way of example, take place by way of a timer with non-volatile memory which always measures the time when the gas discharge lamp burner 50 is being operated, and consequently an arc burns between the electrodes. As the problem of flicker mainly occurs in older lamps, a method is accordingly being proposed in which the operating frequency with which the gas discharge lamp burner is operated is adjusted to the burning time of the gas discharge lamp burner in such a way that the operating frequency increases as the burning time increases. This provides the following advantages: the change from anodic to cathodic operating phase, which accompanies a temperature modulation of the electrode tips, occurs more quickly at a higher frequency. Consequently the temperature surge of the electrode tips is lower at a higher frequency due to their thermal inertia. Surprisingly it has been found that flicker does not occur at an electrode temperature which is above a “critical minimal temperature” of the lamp electrodes.

The frequency must not be increased arbitrarily, however, as otherwise acoustic resonances could be excited in the lamp which may also be accompanied by a deformation of the arc as well as flicker. This effect is possible from frequencies as low as 1 kHz, for which reason a frequency of 400 Hz or 500 Hz is conventionally chosen for normal operation, i.e. following the ignition and start-up phase in the stationary operating phase. This frequency will hereinafter be called the lower limiting frequency. The term “low cumulative burning time” will hereinafter be regarded as a burning time during which the burner 50 of the gas discharge lamp 5 does not yet exhibit any aging effects, or only a very small number. This is the case until the cumulative burning time reaches roughly the first 10% of the specified lifetime of the gas discharge lamp 5. The term “in the vicinity of the specified lifetime” will hereinafter be regarded as a lifetime during which the cumulative burning time slowly reaches the specified lifetime, for example between 90% and 100% of the specified lifetime. The specified lifetime is regarded as the lifetime given by the manufacturer.

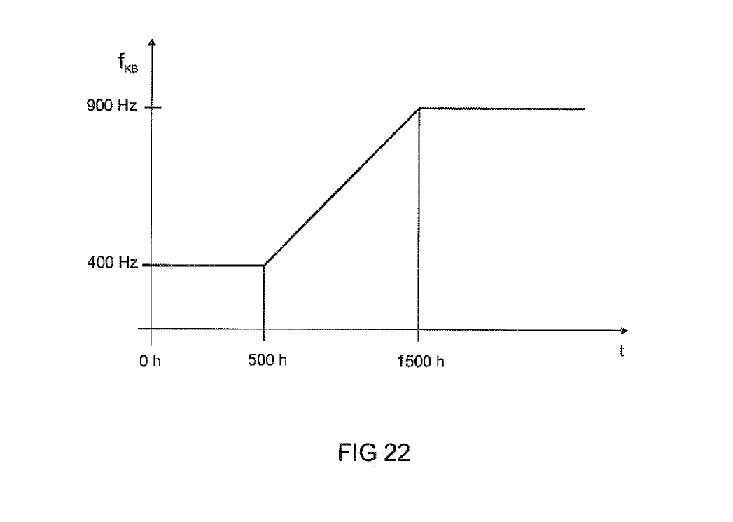

FIG. 22 shows the diagram of a first embodiment of the method in which the operating frequency of the gas discharge lamp burner over its burning time is plotted. It can clearly be seen that up to a burning time of 500 h the operating frequency is constant at 400 Hz, then during the burning time from 500 h to 1,500 h is successively increased by 0.5 Hz/h to 900 Hz to then remain at 900 Hz from this point.

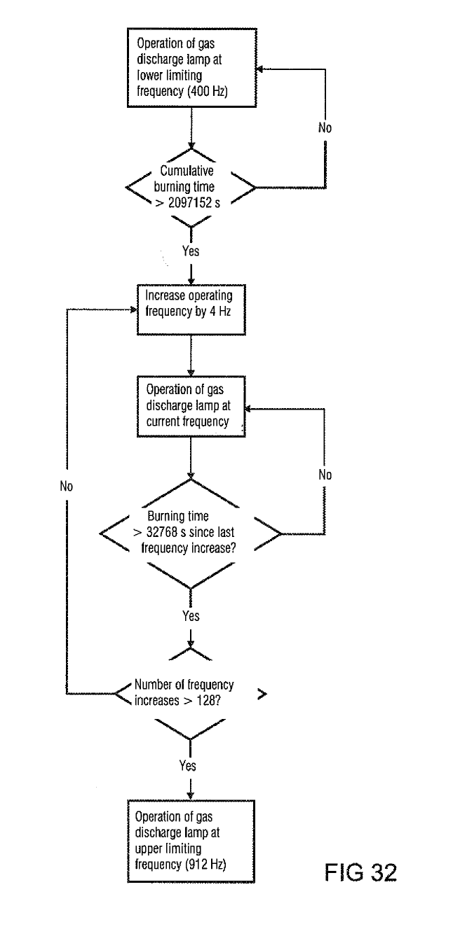

The frequency increase in the range 500 h to 1,500 h does not have to be continuous, however. It may also take place in stages. Therefore in a second variant of the first embodiment of the method, which is shown in FIG. 32, the frequency is increased by 4 Hz from a cumulative burning time of 2097152 s, which roughly corresponds to 583 h, and after every 32768 s, which roughly corresponds to 9.1 h. The frequency is increased until 128 increases have been carried out. The frequency—starting from an original starting value of 400 Hz—has then reached the value 912 Hz. The second variant of the first embodiment of the method is particularly suitable for implementation by means of digital logic, for example by way of a microcontroller or a digital circuit in an ASIC, because it only requires discrete time and frequency steps.

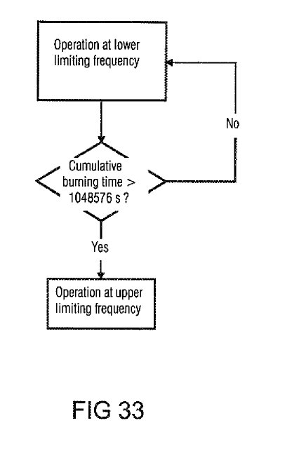

A particularly simple implementation is applied in the third variant of the first embodiment, which is shown in FIG. 33. Here the frequency is doubled in one step from 400 Hz to 800 Hz after a time of 1048576 s, which roughly corresponds to 291 h. The lamp is then always operated at the high frequency. In contrast to the second variant of the first embodiment there is only a single frequency step.

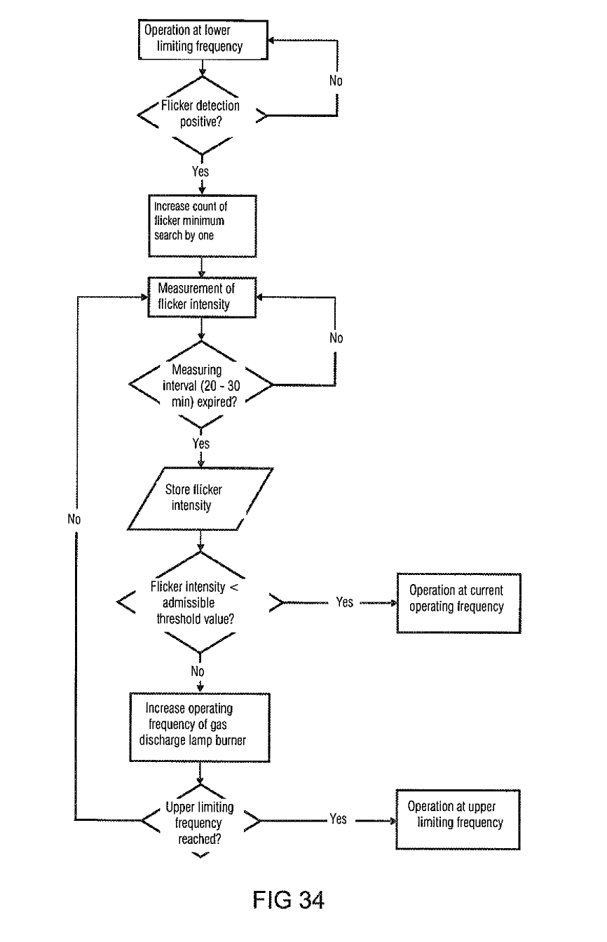

In a second embodiment, which is shown in FIG. 34, the above method is combined with a circuit arrangement for detecting flicker (not shown) to be able to adjust the frequency as needed to the requirements of the lamp burner. The circuit arrangement for detecting flicker is based on a detection circuit which uses the lamp voltage and/or lamp current for detection. Alternatively, suitable correlating variables upstream of the inverter may also be used for detection. An electronic operating device or ballast as is conventionally used in a motor vehicle and can be provided as operating electronics 920 in the integrated gas discharge lamp 5 has a two-stage construction comprising a DC/DC converter and inverter which are coupled together by a DC link, it being possible for the change in current over time of the DC link and/or the change in current over time of the current flowing into the inverter from the link to be considered as a measure of the flicker of the lamp.

The circuit arrangement for detecting flicker now detects whether flickering of the lamp occurs. If this is the case and the previous burning time of the lamp is greater than 500 h a flicker mapping method is initiated.

The method comprises the following steps:
increasing the count of a flicker minimum search by one
incremental increase of the operating frequency of the gas discharge lamp burner starting from the lower limiting frequency,
measuring the flicker intensity at the chosen operating frequency.

At least the flicker intensity at the chosen operating frequency is stored in each case here. If necessary additional parameters, measured at the operating frequency, are stored. The flicker intensity has to be measured over a relatively long period to be able to compensate statistical variations which may occur during operation. In the second embodiment a measuring time of, for example, 20 to 30 minutes is provided. The frequency is increased by 100 Hz each time and the flicker intensity then measured. In a first stage the frequency is increased up to a first upper limiting frequency of 900 Hz. As soon as the flicker stops or the flicker intensity drops below an admissible threshold the frequency is no longer increased, the current frequency is also saved in a non-volatile memory for future operation, so when the integrated lamp is next switched on it is immediately started at the frequency at which it was last operated.

If the flicker could not be eliminated despite an increase up to the first upper limit or the flicker intensity could not be lowered below an admissible threshold, the count of the flicker minimum search is increased by one and the frequency increased further until three times the value of the first upper limiting frequency, in this case 2,700 Hz therefore, what is known as the second upper limiting frequency is reached. The frequency is thereafter purposefully chosen from the entire measured range between the lower limiting frequency and the second upper limiting frequency at which the lowest flicker was evident. The flicker intensity pertaining to the lowest flicker is multiplied by a factor greater than 1 and stored as a new admissible threshold, what is referred to as the current flicker limit.

Monitoring and measuring of flicker remains activated hereafter and a check is periodically made as to whether the current flicker intensity is above the current flicker limit. If this should be the case, a jump is made to the frequency which demonstrated the second-lowest flicker intensity during the above-described examination of the lamp as part of this method. The lamp is then operated at this frequency, with monitoring and measuring of flicker also remaining activated. If the current flicker intensity should lie above the current flicker limit again, a switch is made to the frequency with the third-lowest flicker intensity. If during subsequent operation the current flicker intensity should also lie above the current flicker limit in this case as well, the count of the flicker minimum search is increased by one again and a new search for the minimum is begun, with the entire frequency range between the lower limiting frequency and the second upper limiting frequency being examined.

The count indicating how often the flicker minimum search has already been activated and the current flicker limit are stored in the non-volatile memory of the operating electronics (920, 930). These two values can be read out via the communications interface of the integrated gas discharge lamp, for example via a LIN bus. During maintenance of the motor vehicle, for example as part of an inspection following expiry of a servicing interval, or because the motor vehicle is in the garage due to a defect, the two values are read out and compared with limit values which represent the values that can still be tolerated. The limit values can also be stored in the integrated gas discharge lamp and read out via the communications bus but for the sake of simplicity are stored in the garage's diagnostic apparatus in the preferred embodiment. If one of the read out values lies above the associated limit value the integrated gas discharge lamp (5) should be replaced with a new one. This process considerably increases the availability of the lighting system, without incurring appreciable costs, because the lamp is not replaced unnecessarily early and no significant additional expenditure of time occurs during maintenance because the vehicle is connected to the diagnostic apparatus anyway.

The limit values with which the data from the non-volatile memory of the operating electronics are compared can be changed as a function of the cumulative burning time (tₖ), also read out from the non-volatile memory, or the cumulatively weighted burning time (t_{kg}), so that, for example, the flicker limit of an old lamp may be higher than that of a new lamp without the lamp having to be replaced. The lamp manufacturer provides the vehicle manufacturer with the dependencies of the limit values as a function of the burning time of the lamp, so that the latter can update the data, by way of example in the form of a table or data matrix, in his diagnostic apparatus.

In a third embodiment the procedure is analogous to the second embodiment but in order to save memory in the microcontroller in particular, only the value of the previously minimal flicker intensity that has occurred and the associated operating frequency are stored during the above-described search. This means that instead of real mapping only a minimum search is performed with respect to the flicker intensity. If during the first search process there is no termination of the search, as described above, up to the first upper limiting frequency then, as in the second embodiment, the search continues up to the second upper limiting frequency. The frequency stored in the minimum memory can then be jumped to directly. The lamp is then operated at this frequency for at least 30 min and during this time the flicker intensity is determined over this period. If this is increased by more than an admissible factor, by way of example 20%, with respect to the original, a new search is started for the optimum operating frequency and the process is continued as described above.

By increasing the operating frequency of the gas discharge lamp burner over its burning period the tendency of the burner to flicker can be significantly reduced without cost-intensive measures being necessary on the circuit arrangement itself. Due to the fact that the operating electronics of the integrated gas discharge lamp 5 contain a microcontroller, the entire method can be implemented in the software of the microcontroller, and therefore does not create any additional costs. The circuit arrangement for detecting flicker in the second embodiment can also be implemented purely in terms of software with astute design. As the measured variables necessary for detecting flicker are already present at the microcontroller for other reasons, a detection unit can be implemented in software by way of suitable evaluation of said variables. The circuit components necessary in hardware are present anyway for other reasons and therefore do not create any additional costs.

### Communications Interface

As already stated above, the integrated gas discharge lamps 5 can comprise communication means or at least one communications interface which allows communication with the on-board electronics of the motor vehicle in particular. A LIN bus seems to be particularly advantageous although connection of the integrated gas discharge lamp by means of a CAN bus and the on-board electronics is also possible.

The communications interface means that the lamp can advantageously communicate with the higher-level control system, for example a light module in a motor vehicle. Diverse information about the integrated gas discharge lamp 5 can be transmitted via the communications interface to the higher-level control system. This information is stored in the lamp in a non-volatile memory. Diverse information accumulates during production of the integrated gas discharge lamp 5 and this can be collated by the production plant and is programmed toward the end of lamp production in the non-volatile memory of the lamp. The information can, however, also be written directly into the non-volatile memory of the operating electronics of the integrated gas discharge lamp 5 and a communications interface is therefore not imperative for this.

During production the gas discharge lamp burner 50, for example, is exactly measured and when fitted onto the base 70 is secured to the base in an exactly defined position with respect to a reference plane of the base. This ensures a high quality optical system comprising integrated gas discharge lamp 5 and headlight 3 because the arc burning between the gas discharge lamp electrodes 504 adopts an exact position in space with respect to the reference plane which constitutes the interface to the headlight. The spacing and position of the electrodes for example are consequently known to the production machine. The electrode spacing can constitute an important variable for the operating electronics, however, because the electrode spacing of the gas discharge lamp burner 50 correlates with the burning voltage. A unique serial number or alternatively a production batch number may also be stored in the non-volatile memory of the lamp to ensure traceability. The components used in the integrated gas discharge lamp 5 and all available data can be retrieved via the serial number by way of a database maintained by the manufacturer in order, in the case of production faults in individual parts, to be able find the affected lamps.

In a preferred embodiment of the integrated gas discharge lamp additional parameters measured during lamp operation and stored in the non-volatile memory of the integrated gas discharge lamp 5 can be retrieved and stored via the on-board electronics by means of the communications interface. It may be expedient, for example, to store the data of the optical system, of which the headlight is made up, in the integrated gas discharge lamp 5 because this can control the output of the gas discharge lamp burner 50 in such way that a uniform light output of the headlight system is achieved.

The following communication parameters may be considered in particular:
the cumulative burning time of the gas discharge lamp burner 50,

the number of flicker effects that have occurred, i.e. the number of times the admissible limit value has been exceeded,
the number of starts of the flicker minimum search,
the current lamp power,
the current frequency of the inverter,
the target value of the lamp power (=lamp target power),
the actual value of the lamp power,
the temperature of the electronics,
the serial number or batch number,
the number of lamp extinctions overall and the number of lamp extinctions within a previous period, for example 200 h,
the number of non-ignitions.

In principle conventional operating electronics that are not integrated in the lamp base of the discharge lamp could also have detected these parameters and made them available via a communications interface. However, it would not be possible to use these parameters for a diagnosis when the motor vehicle is being serviced, because the lamp could have been changed at any time irrespective of the operating electronics and the read out parameters consequently need not necessarily describe the system, comprising lamp and operating electronics, present at the time. The described system of an integrated gas discharge lamp 5 in which a gas discharge lamp burner and operating electronics for the gas discharge lamp burner are integrated in a lamp so as to be inseparable from each other has this drawback.

The communications interface is preferably a LIN bus or alternatively a CAN bus. Both interface protocols are common and implemented in the automotive sector. If the integrated gas discharge lamp 5 is not used in a car the communications interface of the integrated gas discharge lamp 5 may also comprise a protocol common in general lighting such as DALI or EIB/Instabus.

On the basis of this data (primarily the cumulative burning time) the higher-level control system present in the motor vehicle can calculate for example the envisaged replacement time of the integrated discharge lamp 5. During an inspection of the motor vehicle a decision can be made as to whether the integrated gas discharge lamp 5 will continue to work properly until the next inspection date, or whether it has to be replaced because, by way of example, poor light quality or even failure of the lamp has to be anticipated.

As the data can be read out via a communications interface of the integrated discharge lamp a service engineer can read the data from the integrated gas discharge lamp and, if required, can replace the lamp before failure, as has already been described above with respect to a flickering lamp.

If data from production of the integrated gas discharge lamp is stored unmodifiably in the non-volatile memory of the operating electronics, the lamp can retrieve this data at any time in its lifetime calculations, whereby the lifetime calculations, i.e. the estimation of the period for how long the integrated gas discharge lamp will work properly, become much more accurate. Data, from which the production period may be derived, is preferably stored in the non-volatile memory of the operating electronics. Potential faulty products or defects in a batch that are only detected later can therefore also still be replaced in the field before the lamp fails. This is very advantageous for users of motor vehicles because use of the integrated gas discharge lamp in a front headlight in particular is an especially safety-related application. If data is stored in the non-volatile memory of the operating electronics via which the integrated gas discharge lamp is clearly identified, the data stored in a database during production can be simply and reliably associated with the lamp. This works particularly efficiently if a clear and unique serial number is stored in the non-volatile memory of the operating electronics. This also contains inter alia a manufacturer code agreed among all manufacturers, so different manufacturers can assign the same type of integrated gas discharge lamp a sequential number during its respective production but it is still ensured that there is no second lamp which has the same serial number.

During operation of the integrated gas discharge lamp one or more number(s) is/are preferably stored in the non-volatile memory which increase(s) with the burning time and/or the number of ignitions of the gas discharge lamp. The burning time of the gas discharge lamp burner is determined in the process, totaled and stored as a cumulative burning time in the non-volatile memory of the operating electronics. The cumulative burning time is preferably stored in the non-volatile memory as a number. The burning time can, however, also be weighted by operating parameters and be stored in the non-volatile memory of the operating electronics as a number, with this number then corresponding to the cumulatively weighted burning time. The different types of cumulative burning time will be discussed in more detail below. The previous burning time can therefore be reliably compared with the lifetime specified by the manufacturer and an accurate statement about the remaining lifetime of the lamp can be made. The lifetime specified by the manufacturer can be a function of additional data also read from the non-volatile memory, so it can, for example, depend on the number of starts or the required light flux of the lamp. The decision as to whether the integrated lamp has to be replaced can, moreover, be made for economic reasons from the data stored in the diagnostic apparatus of the service garage, which has been determined during past garage visits, and therefore the information about how intensively the light has been used within the past service intervals for example can also be used to make the decision.

If a number stored in the non-volatile memory of the operating electronics provides information about the flicker of the lamp, in particular the number of starts of the flicker minimum search or the current flicker limit, the state of the integrated gas discharge lamp can be accurately determined and read out if required. These values can also be used during a service of the motor vehicle, in which the integrated gas discharge lamp is located, to assess the remaining lifetime.

The number of ignitions of the gas discharge lamp burner stored in the non-volatile memory of the operating electronics can also be of interest to the service engineer because the number of ignitions also has an effect on the lifetime like the burning time. During a service of the motor vehicle data is therefore read out of the non-volatile memory of the operating electronics and a different procedure takes place during servicing as a function of the data. Servicing is consequently more efficient and improved, early failures are rare and customer satisfaction increases. The decision as to whether the integrated gas discharge lamp needs to be replaced can be based on the data read out of the non-volatile memory of the operating electronics in addition to the service engineer's experience. The decision to replace the integrated gas discharge lamp is then preferably taken if the cumulative burning time and/or the cumulatively weighted burning time and/or the number of ignitions of the gas discharge lamp is above a certain limit value. The limit value preferably depends on the production time period and/or the data which allows a unique identification of the integrated gas discharge lamp. A reliable and simple decision about replacement of the integrated gas discharge lamp is therefore possible.

### Lumen Constancy

The information stored in the non-volatile memory of the integrated gas discharge lamp 5 may, however, also be used to keep the light output of the integrated gas discharge lamp 5 constant over the lifetime thereof. The light output at nominal power of gas discharge lamps changes over the lifetime thereof. As the burning time increases, the efficiency of the lamp decreases due to blackening and devitrification of the discharge vessel, burn-back of the electrodes and the change in the discharge arc caused thereby. The efficiency of the overall optical system is thereby further decreased, since these systems are conventionally dimensioned for a spot light source or for the shortest discharge arc resulting from the minimum electrode spacing and more light gets lost in the optical system when the discharge arc is elongated. The optical system itself also loses efficiency during its operating time, either due to lens opaqueness or to defocusing caused by temperature cycles or the vibrations permanently occurring in car, headlights. A lamp burning time tₖ and a cumulatively weighted burning time t_{kg} are referred to below, wherein the cumulatively weighted burning time t_{kg} is weighted with a weighting function γ which will be further discussed below.

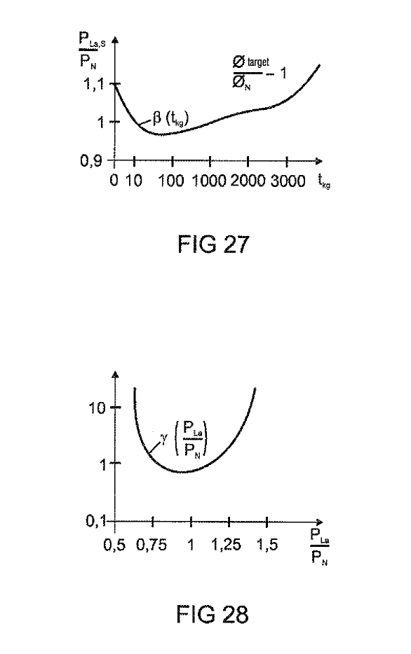

Since the operating electronics of the integrated gas discharge lamp 5 have stored the relevant parameters of the gas discharge lamp burner 50 in the non-volatile memory, they can match the operating power P_{LA} applied to the gas discharge lamp burner 50 to its cumulative burning time. Since the aging process does not proceed linearly, according to a simple embodiment, a compensation function β is stored in the operating electronics, as it is shown in FIG. 27. In this case the cumulatively weighted burning time t_{kg} of the lamp is plotted against the quotient of the lamp power P_{LA} to the nominal power P_{N} of the gas discharge lamp burner 50. In the lower range below 10 h burning time, the power is slightly increased. This is to help condition the gas discharge lamp burner 50. This is also known as “burning-in” of the gas discharge lamp burner 50 of the integrated gas discharge lamp 5. When the lamp is burned in, it is operated with slightly reduced power (approximately 90% of the nominal power), since the efficiency of the lamp as well as of the optical system is still very good. From a cumulatively weighted burning time t_{kg} of approximately 100 h on, the power slowly increases again, in order to reach a lamp power P_{La}, which is approximately 10% higher than the specified nominal lamp burner power, on reaching the specified lifetime end of 3,000 h. The light output of the gas discharge lamp burner is therefore substantially constant over its burning time. The function stored in the operating electronics can be influenced by burner parameters, such as the electrode spacing, stored in the non-volatile memory.

In an advanced system having control of the integrated gas discharge lamp 5 by way of a higher-level control system, further light functions, such as speed-dependent control of the amount of light emitted, may be achieved. In such an advanced embodiment, the operating electronics are designed such that they can operate the gas discharge lamp burner 50 at an underpower or an overpower. However, if the gas discharge lamp burner 50 is not operated at nominal power, then it ages differently compared to operation at nominal power. This has to be taken into consideration in the calculation of the cumulative burning time. For this purpose a weighting function γ is stored in the operating electronics, which represents a factor dependent on the underpower or overpower. FIG. 28 shows the weighting function γ for an integrated gas discharge lamp 5 designed for use in the front headlight of a motor vehicle. If the gas discharge lamp burner 50 is operated at overpower, it ages faster, since the electrodes become too hot and electrode material evaporates. If the gas discharge lamp burner 50 is operated with significant underpower, then it again ages faster, since the electrodes are too cold and, hence, electrode material will be sputtered-off, whereby electrode material will be removed by sputtering, which is undesirable since this reduces the lifetime of the lamp and reduces the light yield. Therefore, the operating electronics of the integrated gas discharge lamp 5 have to include this aging in the calculation of the cumulatively weighted burning time t_{kg}. This may, for example, be done by the following formula:

$${t}_{kg} ( t ) {\int }_{0 h}^{t} f ( τ ) \cdot γ ( \frac{{P}_{LA} ( τ )}{{P}_{N}} ) d τ .$$

In this respect the function f(τ) only stands for the burning function, i.e. as soon as the gas discharge lamp burner 50 is operating, f(τ)=1, and when the gas discharge lamp burner is not operating, f(τ)=0. Accordingly, when the integrated gas discharge lamp 5 is operated at underpower or overpower, it ages faster by a factor of as much as ten.

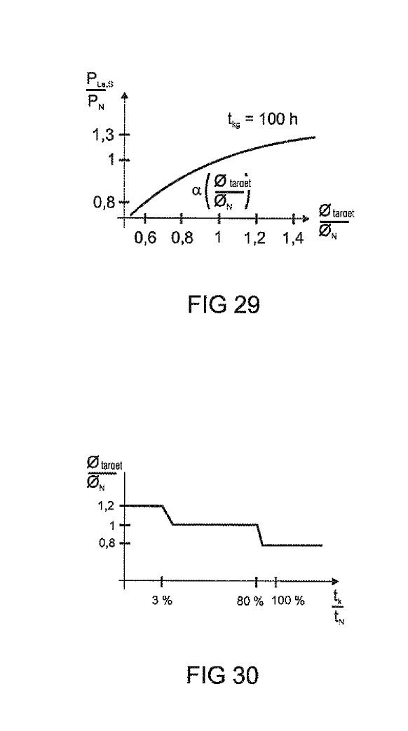

In an advanced control system, which can operate the gas discharge lamp burner 50 at overpower or underpower, advanced communication with the higher-level control device can also be implemented. This may be provided such that the higher-level control device no longer requests a certain power from the integrated gas discharged lamp 5, but requests a predetermined amount of light. In order to achieve this, a dimming curve is stored in the operating electronics of the integrated gas discharge lamp 5. FIG. 29 shows such a dimming curve a using the example of an integrated gas discharge lamp 5 for the automotive industry. The dimming curve shows the dependency of the light flux Φ_{target} emitted by the gas discharge lamp burner 50, or the light flux

$$\frac{{φ}_{target}}{{φ}_{N}}$$

normalized to the nominal light flux Φ_{N}, as shown in FIG. 29, on the burner electrical power P_{LA, S}, or the burner electrical power

$$\frac{{P}_{La , S}}{{P}_{N}}$$

normalized to the nominal burner electrical power P_{N}, as shown in FIG. 29. In FIG. 29 this is plotted for a cumulatively weighted burning time t_{kg} of the gas discharge lamp burner 50 of 100 h. Other curve characteristics will result for a different cumulatively weighted burning time t_{kg} of the gas discharge lamp burner 50. In the ideal case a three-dimensional characteristics map is therefore stored in the operating electronics of the integrated gas discharge lamp 5, which takes into consideration the age of the gas discharge lamp burner 50. Thus, FIG. 29 is only a section through the characteristics map for a cumulatively weighted burning time t_{kg} of the gas discharge lamp burner of 100 h. The characteristics map for determining the lamp power may include further dimensions in addition to the light flux and the cumulatively weighted burning time, such as the burning time since the last ignition of the lamp or the estimated burner temperature in order to map in particular effects in the range up to few minutes after ignition, caused by thermal transients during what is referred to as the lamp “run-up”, during which, among other things, vaporization of the filling occurs. The dimming curve does not necessarily have to be stored as a characteristics map in the operating electronics of the integrated gas discharge lamp 5 but can also be stored as a function so it can be calculated by a microcontroller integrated in the operating electronics. In order to be able to implement the calculation of the lamp power to be set as easily as possible, the underlying function or the corresponding family of characteristics may be approximately expressed by a product, wherein as factors, in addition to the nominal power P_{N} of the gas discharge lamp burner, each individual factor describes the effect of one of the above-mentioned parameters. Therefore the required burner power P_{La} for a certain amount of light can be expressed by way of example by the following formula:

$${P}_{La} = {P}_{N} \cdot α ( \frac{{φ}_{target}}{{φ}_{N}} ) \cdot β ( {t}_{kg} ) .$$

In this respect the factor β takes into consideration the aging of the gas discharge lamp burner 50. The function β may also include the aging of the optical system, wherein this data is preferably communicated via the communications interface of the integrated gas discharge lamp so these effects can also be taken into consideration in the calculation of the operating electronics of the integrated gas discharge lamp. In this respect the amount of light specified by the control device may be dependent, for example, on the speed of a motor vehicle, in which the integrated gas discharge lamp 5 is operated. At slow speed, for example, the lamp is operated in a dimmed manner, whereas at high speed, such as on the freeway, it is operated slightly above nominal power in order to ensure a wide view and a good illumination of the roadway.

In advanced operating electronics of a further embodiment of the integrated gas discharge lamp 5, the previous burning time of the gas discharge lamp burner 50 during operation can also or additionally be taken into consideration. If the cumulatively weighted burning time t_{kg} approaches the specified lifetime end of the gas discharge lamp burner, the operating electronics can operate the burner at a power which lets it age at the lowest rate and therefore effectively increases its lifetime compared with conventional operation. FIG. 30 shows such an exemplary burner preserving curve, in which the light flux quotient

$$\frac{{φ}_{target}}{{φ}_{N}}$$

is plotted against the cumulative normalized lifetime

$$\frac{{t}_{k}}{{t}_{N}} .$$

The latter is calculated from the lamp burning time tₖ divided by the nominal lifetime t_{N} of the lamp of, for example, 3,000 hours. Up to 3% of its nominal lifetime, the gas discharge lamp burner 50 is operated at 1.2 times its nominal power in order to condition and burn-in the gas discharge lamp burner 50. Thereafter the gas discharge lamp burner 50 is operated at nominal power for a relatively long time. When the gas discharge lamp burner 50 reaches 80% of its lifetime, the power is reduced successively to about 0.8 times the nominal power. The weighting function in FIG. 28 discloses on closer consideration that the lamp is best preserved when being operated at about 0.8 times its nominal power. Therefore the integrated gas discharge lamp 5 will be operated at this power when approaching the end of its lifetime in order to ensure a remaining lifetime which is as long as possible and to, avoid a sudden lamp failure which may have a fatal outcome in particular in the automotive sector. Instead of the lamp burning time tₖ, the cumulatively weighted burning time t_{kg} may also be used in contrast to the depiction in FIG. 30.

On the basis of the above-mentioned data and calculations, the integrated gas discharge lamp 5 can calculate the expected remaining lifetime of its gas discharge lamp burner, and can store it in a non-volatile memory of the operating electronics 220, 230. Therefore if the motor vehicle is in the garage for inspection, lamp data of interest for the inspection, in particular the stored remaining lifetime, may be read out. On the basis of the read out remaining lifetime it may then be decided whether the integrated gas discharge lamp 5 needs to be replaced. It is also possible that the serial number of the integrated gas discharge lamp and/or the serial number of the gas discharge lamp burner 50 is/are stored in the integrated gas discharge lamp 5. On the basis of the serial number, the mechanic in the garage can query via a manufacturer database whether the lamp is OK or has to be replaced, possibly because of defects in the manufacture or because of defects on the components incorporated therein.

In a further advantageous embodiment of the integrated gas discharge lamp 5 and in contrast to the previously described embodiment, the expected remaining lifetime will not be read out in the garage, but the data as to how the lamp has been actually operated will be read out. This data will then be evaluated by the diagnostic apparatus on the basis of the nominal data, pertaining to the respective serial number, from the manufacturer database. For example, the nominal lifetime t_{N} of a lamp having a given serial number is stored in the manufacturer database. This would be correspondingly low in case of product defects. Since further data about the operation will also be stored in the operating electronics, such as number of ignitions, these parameters may also be compared with the manufacturer database, which then, for example, includes the number of nominal ignitions for each lamp. A high number of ignitions, read out from the operating electronics, which approaches the nominal ignitions, results in the decision to replace the lamp, even though, for example, the nominal lifetime of the lamp has not yet been reached. By using such criteria, the availability of the light source is increased in an economical manner. This procedure has to be seen as being particularly economical because the lamp will be replaced only when the likelihood of its imminent failure is high. The manufacturer of the lamp is encoded in the first bit of the serial number of the lamp ensuring that the serial number remains unique, even though possibly several lamp manufacturers produce interchangeable products. When retrieving nominal data, such as the nominal lifetime or the nominal ignitions, from the manufacturer database via a communications link between the garage and the lamp manufacturer, for example via an Internet connection, the operation-related data read out from the operating electronics is transmitted in return to the lamp manufacturer. Accordingly a bi-directional data exchange occurs between the operating electronics of the lamp and the manufacturer database. On the one hand this allows tracking of products in the field, in particular a statistical survey about how the product is used, and this is very advantageous regarding further product development in particular. However, an individual data survey is also possible insofar as, for example, the VIN (Vehicle Identification Number) of the vehicle is transmitted in addition to the serial number. Furthermore, the possibility of protection against product counterfeiting is offered. The latter is achieved in that in case of product counterfeiting the serial number has to be copied too, which, when transmitting the data to the manufacturer, eventually leads to an apparent data inconsistency, since, for example, the operating hours which are assigned to a serial number cannot decrease again, which allows a corresponding conclusion to be drawn that counterfeited products are involved.

### Arc Straightening

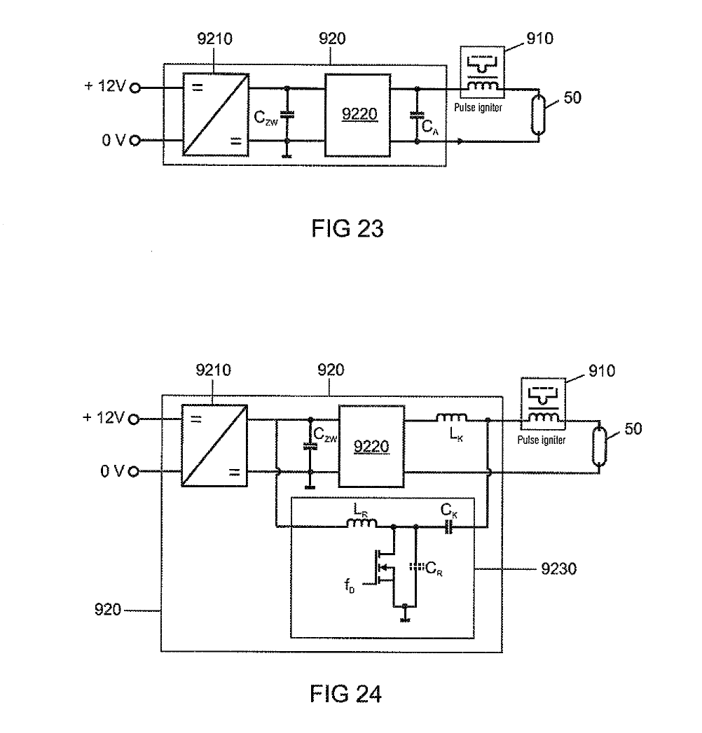

A method for straightening the discharge arc of the gas discharge lamp burner will be described hereinafter, which is implemented in an embodiment of the integrated gas discharge lamp 5. A first embodiment is based on operating electronics 920 having a topology according to FIG. 23. In this respect the operating electronics 920 include a DC/DC voltage converter 9210 which is supplied by the battery voltage of a motor vehicle. An inverter 9220 is connected downstream of the DC/DC voltage converter via a DC link capacitor, which supplies AC voltage to a gas discharge lamp burner 50 via a lamp circuit. The lamp circuit consists of an output capacitor C_{A} and the ignition electronics 910, with the primary winding of the ignition transformer in the lamp circuit, and the gas discharge lamp burner 50. By means of this topology, which is largely known from the prior art, a straightening of the discharge arc can be achieved by appropriate configuration of the components.

A straightened discharge arc offers many advantages. A first significant advantage is the improved thermal balance of the gas discharge lamp burner 50, obtained by a more even thermal wall stress of the burner vessel. This leads to a better thermal utilization and, thus, to a longer lifetime of the burner vessel. A second significant advantage is a contracted light arc which has a reduced diffusivity. With such a ‘narrower’ arc, the optical system of a headlight, for example, can be more precise and the light yield of the headlight can be significantly increased.

Since the ignition and operating electronics 910, 920 or the overall operating electronics 930 (also called operating electronics below) in the integrated gas discharge lamp 5 are inseparably connected to the gas discharge lamp burner 50, the operating electronics can calibrate to the gas discharge burner 50 in order to generate a stably burning straight arc. Since due to the inseparability of the operating electronics 920, 930 and the gas discharge lamp burner 50 the burning time of the gas discharge lamp burner 50 is also known, aging effects of the gas discharge lamp burner 50 can influence the mode of operation of the gas discharge lamp burner 50.

The basic procedure for straightening the arc of the integrated gas discharge lamp 5 is as follows: The operating electronics 920, 930 measures the gas discharge lamp burner 50 with regard to acoustic resonances when first switched on and detects the frequencies suitable for arc straightening. This is carried out by scanning through the frequency ranges between a minimum frequency and a maximum frequency. The frequencies are modulated onto the operating frequency of the integrated gas discharge lamp burners. During scanning the impedance of the gas discharge lamp burner is measured and the lowest impedance is stored with the corresponding frequency. This frequency with the lowest impedance characterizes the maximum achievable arc straightening. Depending on the lamp type the minimum frequency can fall to a frequency of 80 kHz, and the maximum frequency may reach a frequency of about 300 kHz. In a typical high pressure discharge lamp for automotive applications the minimum frequency is around 110 kHz and the maximum frequency is around 160 kHz. Measuring is required to compensate for manufacturing tolerances of the gas discharge lamp burner 50. Typical aging in respect of the resonant frequencies of the lamp is stored in a microcontroller (not shown) of the operating electronics 920, 930, for example in a table. The values in the table may be stored as a function of the mode of operation of the gas discharge lamp burner (cycle shape, start-up or dimmed operation). In addition, in a further embodiment, the controlled operation may be extended by a regulated modulation operation with a modulation frequency in a narrow range around the calculated frequency (in accordance with the controlled operation). The calculated frequency is modulated with a modulation frequency of, for example, 1 kHz in order to prevent possible flicker phenomena by stimulation of acoustic resonances in the gas discharge lamp burner 50. Compared with previous operating devices according to the prior art one advantage is that now the frequency range (within which the frequency is allowed to be varied) is very small, and the problems regarding going out lamps or non-stable controller behavior are less serious. Nevertheless, it may be expedient with certain types of lamps to measure the frequency ranges around the actual modulation frequency with respect to their flicker behavior in order to be able to ensure stable lamp operation. For this purpose in one embodiment the circuit arrangement for detecting flicker is used, and frequencies close to the modulation frequency are measured with regard to their flicker behavior.

In a first embodiment according to FIG. 23, the frequency of the DC/DC voltage converter 9210 is selected to be equal to the modulation frequency. By corresponding design of the DC link capacitor C_{ZW}, a high frequency ripple remains as a high-frequency AC voltage modulated onto the DC voltage output by the DC/DC voltage converter 9210. The DC voltage with the modulated high-frequency AC voltage serves as an input voltage for the inverter 9220. In this case the inverter 9220 is provided as a full bridge which converts the DC voltage into a square wave AC voltage. The amplitude of the modulation signal, i.e. of the modulated high-frequency AC voltage, is determined by the dimensioning of the output filter of the full bridge (output capacitor C_{A}) as well as by the inductance of the secondary winding (IPSH, IPSR) of the pulse ignition transformer. Due to the fact that in the integrated gas discharge lamp 5 these components are inseparably connected to each other, good adjustment of these components to the desired mode of operation is possible. The desired straightening of the discharge arc occurs by means of the superimposed high-frequency voltage. The drawback of this embodiment is the fixed-frequency mode of operation of the DC/DC voltage converter, which does not allow an effective switching relief so that system losses will increase.

In a second embodiment according to FIG. 24, the superimposed high-frequency voltage is generated by a signal generator 9230. This injects the high-frequency voltage in the lamp circuit between a choke L_{K} and the primary winding of the ignition transformer of the ignition electronics 910. Injection upstream of the ignition transformer is important, as the signal generator 9230 would otherwise have to be implemented in a high voltage-proof manner. The choke serves to decouple the DC link capacitor C_{ZK}, since it otherwise would damp the injected high-frequency voltage too much. For this reason, the inductance of the ignition transformer of the ignition electronics 910 should be as small as possible. The signal generator can be designed such that the frequency of the injected high-frequency voltage is in turn modulated in order to achieve more reliable and flicker-free operation of the gas discharge lamp burner 50.

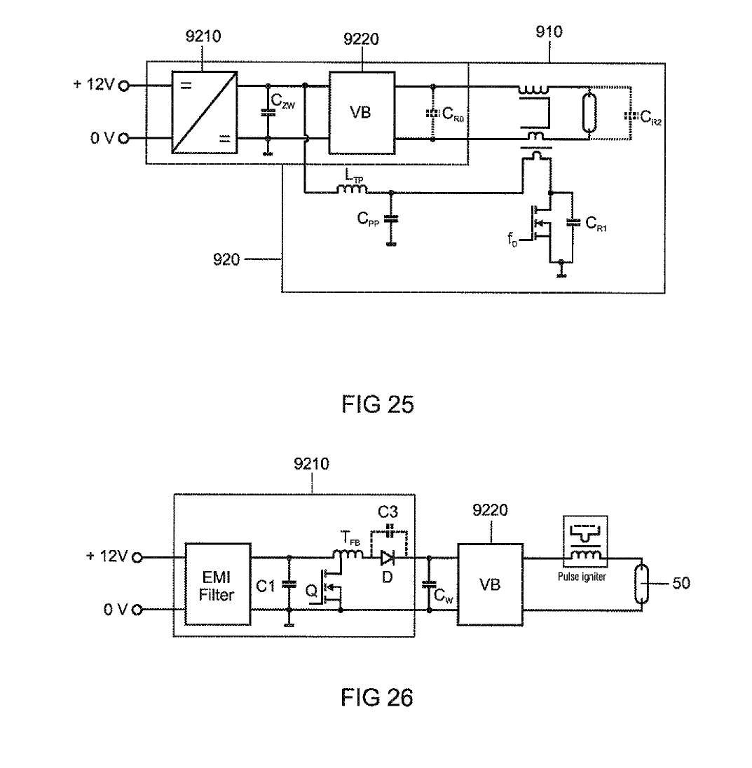

In a third embodiment which is shown in FIG. 25, the signal generator is integrated in the ignition electronics 910. In this case the gas discharge lamp burner 50 is started by resonance ignition. The ignition electronics comprise an ignition transformer T_{IR} designed for high-frequency operation and controlled by a signal generator which is embodied as class E converter. The ignition transformer T_{IR} must be dimensioned such that it can still sufficiently effectively transmit at least the fundamental wave of the high frequency occurring and which is identical to the switching frequency of the class E converter, in particular that its efficiency at this frequency is higher than 10%. The switching frequency of the class E converter during the ignition has a value between 80 kHz and 10 MHz. However, the frequency is preferably selected to be above 300 kHz, since this allows a small design, and below 4 MHz, since in this case the achievable efficiencies are particularly high. The ignition transformer is controlled via a galvanically separated primary winding. The secondary winding is divided into two galvanically separated windings, which are each connected between a lamp electrode and the inverter 9220. In this case the signal generator generates a high-frequency current through the primary winding of the ignition transformer T_{IR}, which excites a resonance in a resonance circuit on the secondary side, which allows the gas discharge lamp burner 50 to break down. The resonance circuit here consists of the secondary inductance of the ignition transformer T_{IR} and a capacitance C_{R2} across the lamp. Since the capacitance C_{R2} is very small, it does not necessarily have to be integrated as a component in the ignition electronics 910, but may be created by design measures.

As soon as the gas discharge lamp burner 50 has ignited, the mode of operation of the signal generator is changed so it now injects a high-frequency signal via the ignition transformer T_{IR}, which is modulated onto the lamp voltage for arc straightening. This has the advantage that the frequency and the amplitude of the modulated voltage are relatively freely adjustable without having to dispense with an optimized mode of operation of the DC/DC voltage converter 9210 or of the inverter 9220. This circuit topology enables the ignition electronics 910 also to provide an increased transfer voltage, generated via the resonance circuit, for the gas discharge lamp burner 50 so it does not have to be generated by the DC/DC voltage converter 9210. With this measure the mode of operation of the DC/DC voltage converter can be further optimized, since the required output voltage range of the DC-voltage 9210 becomes smaller. In addition, the inverter 9220 has to convert less power, since part of the lamp power is injected via the modulated lamp voltage. This embodiment therefore offers the greatest freedom for implementing the operating parameters, thereby permitting optimized and reliable operation of the gas discharge lamp burner 50 with a straightened discharge arc.

FIG. 26 shows an embodiment, which is simplified in comparison with the prior art, of a DC/DC voltage converter 9210. The DC/DC voltage converters normally used in the prior art for ballast devices, which can be operated on an on-board supply system, include a flyback converter topology, since the on-board voltage has to be stepped up from 12V to a higher voltage. Due to the fact that in the integrated gas discharge lamp 5 the electrical contacting only occurs during insertion of the lamp into the headlight 3, a simplified converter in the form of a step-up converter, which is also referred to as boost converter, with an autotransformer T_{FB} may also be used. This is possible since, with the electromechanical interface used, accidental contacting of the converter output with the vehicle ground, which would result in a destruction of the boost converter, can be excluded. The DC/DC voltage converters in flyback converter topology previously used in the prior art allow an interruption in the power flow, in spite of a short circuit on the output side. This is not the case in the present converter concept according to FIG. 26, since in this case no galvanic separation is provided in the power path of the converter, which could interrupt the power flow from the input, i.e. from the 12 V on-board supply, to the output, i.e. to the power supply line of the gas discharge lamp burner 50, which was accidentally connected to the vehicle ground. Otherwise the DC/DC voltage converter is conventionally designed. It consists of an input side EMI filter, an input capacitor Cl, a converter switch Q, an inductance T_{FB} provided as an autotransformer, which acts on the DC link capacitor C_{ZW} via a diode D. This converter is much less expensive than the flyback converters used in the prior art, which means that the integrated gas discharge lamp 5 is significantly less expensive in system terms than a prior art lamp system having a gas discharge lamp and an external electronic operating device.

### LIST OF REFERENCE NUMERALS

20 Electronic operating device
210 Electrical contact
220 Electrical contact
230 Electrical contact
240 Electrical contact
3 Headlight
33 Headlight reflector
35 Carrier part with counter contacts
350 Counter contacts
351, 352 Slots
5 Integrated gas discharge lamp
50 Gas discharge lamp burner
502 Discharge vessel
504 Electrodes
506 Molybdenum foil
52 Metal clip for retaining the gas discharge lamp burner
53 Retaining plate for metal clip
54 Metallic coating of the outer bulb
56 Power supply, close to the base, of the gas discharge lamp burner
57 Power supply remote from the base
70 Lamp base
702 Reference ring
703 Knobs issuing from the reference ring
705 Retaining clip for gas discharge lamp
7051 Groove into which the retaining clip hooks
7053 Bulge in the retaining clip
71 Sealing ring to the reflector
72 Electrically conductive housing
722 Tongues
73 Sealing ring between base plate and base
74 Base plate
741 Base plate dome
80 Ignition transformer
81 Ferrite core
811 First ferrite core half
8110 First half of the inner part of the ferrite core
8112 Side wall of the first ferrite core half
81121 Elongate indentations
812 Second ferrite core half
814-816 Return ferrite
8120 Second half of the inner part of the ferrite core
8122 Side wall of the second ferrite core half
81221 Elongate indentations
821 Hollow cylinder
822 Round plates
823 Slot
824 Hollow cylindrical central core
825 first plate
826 Second Plate
827 Shoulder
85 Contact body
851 First roof area
852 Second roof area
86 Primary winding
861, 863, 865 Cylindrical, inwardly pointing curves
862, 864 Tongues for electrical contacting
8620, 8640 Radii or rounded portions at the ends of the sheet metal strip of the primary winding
866-869 Securing tongues for mechanical securing
87 Secondary winding
871 Inner end of the secondary winding
872 Outer end of the secondary winding
910 Ignition electronics
920 Operating electronics
930 Overall operating electronics
9210 DC/DC converter
9220 Inverter
9230 Signal generator

1. An integrated gas discharge lamp, wherein a gas discharge lamp burner and operating electronics for the gas discharge lamp burner are integrated in a lamp, and wherein the operating electronics control the power of the gas discharge lamp burner as a function of the burning time thereof in such a way that the level of the light output of the integrated gas discharge lamp follows a target value curve
$$( \frac{{φ}_{target}}{{φ}_{N}} ) .$$

2. The integrated gas discharge lamp as claimed in claim 1, wherein the target value is always the same over the entire lifetime of the integrated gas discharge lamp.

3. The integrated gas discharge lamp as claimed in claim 1, wherein the operating electronics of the integrated gas discharge lamp comprise a non-volatile memory, the burning time of the gas discharge lamp burner is determined, totaled and stored as a cumulative burning time in the non-volatile memory of the operating electronics.

4. The integrated gas discharge lamp as claimed in claim 3, wherein the operating electronics calculate the power to be output to the gas discharge lamp burner from at least the following data stored in a non-volatile memory:
the cumulative burning time,
the burner start counted by the operating electronics,
the gas discharge lamp burner data, and
a compensation function.

5. The integrated gas discharge lamp as claimed in claim 4, wherein the gas discharge lamp burner data is written into the non-volatile memory during production of the integrated gas discharge lamp.

6. The integrated gas discharge lamp as claimed in claim 1, wherein the integrated gas discharge lamp comprises a communications interface.

7. The integrated gas discharge lamp as claimed in claim 6, wherein the integrated gas discharge lamp is connected via the communications interface to a higher-level control system and is controlled by said control system.

8. The integrated gas discharge lamp as claimed in claim 6, wherein the integrated gas discharge lamp receives data via the communications interface about an optical system on which it is operated and includes this data in the calculation of the power to be output to the gas discharge lamp burner.

9. The integrated gas discharge lamp as claimed in claim 6, wherein the gas discharge lamp burner data is written into the non-volatile memory via the communications interface during production of the integrated gas discharge lamp.

10. The integrated gas discharge lamp as claimed in claim 1, wherein the integrated gas discharge lamp stores information about operation of the gas discharge lamp burner in the non-volatile memory and this information can be retrieved by the higher-level control system.

11. The integrated gas discharge lamp as claimed in claim 3, wherein the cumulative burning time is weighted with a weighting function to form a cumulatively weighted burning time.

12. The integrated gas discharge lamp as claimed in claim 1, wherein the higher-level control system can specify a target light flux from which a power is then calculated by the operating electronics of the integrated gas discharge lamp as a function of:
the cumulatively weighted burning time,
the burner start counted by the operating electronics,
the gas discharge lamp burner data,
a compensation function, and
a dimming curve,
which power is applied to the gas discharge lamp burner.

13. The integrated gas discharge lamp as claimed in claim 12, wherein the dimming curve is a three-dimensional characteristics map.

14. The integrated gas discharge lamp as claimed in claim 13, wherein the dimming curve is a function from which the three-dimensional characteristics map can be calculated.
